(19) United States
(12) Patent Application Publication
(10) Pub. No.: US 2026/0310657 A1
(43) Pub. Date: Oct. 8, 2026

(54) SYSTEMS AND METHODS FOR CONTEXT-AWARE QUERY INTERPRETATION USING GENERATIVE ARTIFICIAL INTELLIGENCE MODELS

(71) Applicant: Accenture Global Solutions Limited, Dublin (IE)

(72) Inventors: Chellappan MURUGAPPAN, Chennai (IN); Papiya BATABYAL, Chennai (IN); Deepak Kumar MALVIYA, Bangalore (IN); Padmini PATEL, Mumbai (IN); Chitra Ashok PHADKE, Basking Ridge, NJ (US); Ricardo Héctor DI PASQUALE, Ciudad Autónoma de Buenos Aires (AR); Marko KREMA, Evanston, IL (US); Bhagwat SINGH, Gurugram (IN); María Paz GELPI, Mar del Plata (AR); Balasubramaniam RAMACHANDRAN, Chennai (IN); José Ramón CABREJAS, Madrid (ES); Suchit MALHOTRA, Gautam Buddh Nagar (IN); Ragav DEVANATHAN, Chennai (IN); Rajendra PRASAD TANNIRU, Basking Ridge, NJ (US)

(73) Assignee: Accenture Global Solutions Limited, Dublin (IE)

(21) Appl. No.: 19/543,209

(22) Filed: Feb. 18, 2026

(30) Foreign Application Priority Data
Apr. 4, 2025 (EP) 25382342.1

(51) Int. Cl. G06F 16/242; G06F 16/2457; G06F 16/28

(52) U.S. Cl. CPC G06F 16/242; G06F 16/24578; G06F 16/285

(57) ABSTRACT

Systems and methods for context-aware query interpretation using Generative Artificial Intelligence (GenAI) models is disclosed. The system receives a request for generating a response corresponding to a domain from user. The system identifies entities and an intent of the request received. Also, the system determines candidate tables, fields, metrics, and/or dimensions. The system generates candidate executable database query followed by validating the candidate executable database query. The system generates output data by executing the validated executable database query. Moreover, the system computes a confidence score for the validated executable database query. The system generates a response based on the computed confidence score and the generated output data. Consequently, the system outputs the response on a user interface of a user device.

### PRIORITY

The present application claims priority under 35 U.S.C. 119(a)-(d) to EP Patent Application Number 25382342.1, having a filing date of Apr. 4, 2024, the disclosures of which are hereby incorporated by reference in their entirety.

### TECHNICAL FIELD

Various examples described herein relate generally to context-aware query interpretation and, specifically, systems and methods for context-aware query interpretation using Generative Artificial Intelligence (GenAI) models.

### BACKGROUND

Since the introduction of large language models (LLMs) a few years ago, many use cases have emerged that facilitate information extraction, abstraction, and generation through natural language queries. Most of these use cases may focus on textual data sources as core knowledge base and employ techniques, such as Retrieval-Augmented Generation (RAG) to ensure that the data fetched, and the generated response are relevant to the posed questions. Typically, the output is in the form of English sentences, which have fewer strict norms of correctness and accuracy given their generative nature.

### SUMMARY

Implementations of the present disclosure are generally related to context-aware query interpretation. More particularly, implementations of the present disclosure are directed to systems and methods for context-aware query interpretation using Generative Artificial Intelligence (GenAI) models.

In general, aspects of the subject matter described herein provide GenAI based systems and methods for context-aware query interpretation, performed by the system. The system may include a memory configured to store processor-executable instructions and a processor communicably coupled with the one or more memory and configured to execute the processor-executable instructions. The system may receive a request for generating a response corresponding to a domain from a user. Herein, the request may include a natural language query. The system may identify entities and an intent of the received request by parsing the natural language query using a hybrid vector and graph model. The system may determine candidate tables, fields, metrics, and/or dimensions relevant to the natural language query by querying a knowledge graph based on the identified entities and the intent. The knowledge graph may include table metadata nodes, field nodes, dimension nodes, organization term nodes, organization metric nodes, synonym nodes, acronym nodes, user-query nodes, tip nodes, table-behavior nodes, and/or weighted relationships between each type of node. The system may generate one or more candidate executable database queries based on the determined candidate tables, the fields, the metrics, and the dimensions relevant to the natural language query using one or more GenAI models. The system may validate the generated one or more candidate executable database query using a syntactic analysis model and may iteratively refine the one or more candidate executable database query to generate a validated executable database query. The system may generate output data corresponding to the natural language query by executing the validated executable database query on one or more structured data source. Further, the system may compute a confidence score for the validated executable database query based on quantitative metrics and/or qualitative metrics using a classifier model. The system may generate a response to the natural language query based on the computed confidence score and the generated output data. The response may include the computed confidence score, and an explanation of reasoning performed in generating and validating the executable database query. Consequently, the system may output the response on a user interface of a user device.

The present disclosure further describes a method for implementation by the system provided herein. The present disclosure also describes non-transitory computer-readable medium (CRM) coupled to one or more processors and including instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the provided aspects and features.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example environment used to execute implementations of the present disclosure.

FIG. 2 illustrates an example architecture of the back-end system for context-aware query interpretation using Generative Artificial Intelligence (GenAI) models, in accordance with implementations of the present disclosure.

FIG. 2A illustrates an example block diagram of a user interface core module, in accordance with implementations of the present disclosure.

FIG. 2B illustrates an example flow diagram depicting workflow for a user interacting with the back-end system, in accordance with implementations of the present disclosure.

FIG. 2C illustrates an example flow diagram depicting an user action workflow on a user interface, in accordance with implementations of the present disclosure.

FIG. 3 illustrates an example block diagram of an entity and intent module, in accordance with implementations of the present disclosure.

FIG. 4 illustrates an example block diagram of a validation module, in accordance with implementations of the present disclosure.

FIG. 5 illustrates an example block diagram of a confidence score module, in accordance with implementations of the present disclosure.

FIG. 6 illustrates an example block diagram of a response generation module, in accordance with implementations of the present disclosure.

FIG. 7 illustrates an example block diagram depicting generation of a knowledge graph by the entities and intent module, in accordance with implementations of the present disclosure.

FIG. 7A depicts an example graph structure, in accordance with implementations of the present disclosure.

FIG. 7B depicts an example representation of the knowledge graph, in accordance with implementations of the present disclosure.

FIGS. 8A-8F depict example display of output response on the user interface of a user device, in accordance with implementations of the present disclosure.

FIG. 9 illustrates an example flow diagram depicting back-end system's security framework, in accordance with implementations of the present disclosure.

FIG. 10 illustrates a flow diagram of an example method for context-aware query interpretation using the GenAI models, in accordance with implementations of the present disclosure.

FIG. 11 illustrates a computer system that may be used to implement the back-end system disclosed in the example environment of FIG. 1 for context-aware query interpretation using GenAI models, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, “by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring details of the examples.

The specifications and drawings are to be regarded in an illustrative rather than a restrictive sense. It will, however, be evident that various modifications and changes may be made thereunto without departing from the broader spirit and scope of the invention as set forth in the claims.

The rise of large language models (LLMs) and Generative AI solutions has led to numerous methods and systems which may provide instant information and analyze large volume of documents. The examples of traditional system of query interpretation may include customer chatbots which may use manuals to answer questions. However, traditionally, enterprise data stores are large and complex including numerous tables and columns and complex relationships between the tables and columns. The enterprise data stores have evolved over time due to incremental needs of the organization, resulting in data duplications, inconsistent or incomplete data and tables which are outdated. Moreover, knowledge about what each data table includes may be sparse and limited to users with technical expertise (for example, data experts).

The present disclosure discloses the systems and methods for context-aware query interpretation using Generative Artificial Intelligence (GenAI) models. The present disclosure may enable users to determine detailed insights through natural language queries from the structured and un-structured data stored in the enterprise database. The responses to the user queries may be presented as datasets in the form of charts or key performance indicators (KPI) values. The users may view the confidence scores, which may indicate the level of certainty the GenAI model has regarding the responses, accompanied by detailed explanations of the responses. The present disclosure may also enable users to provide feedback on the response. Additionally, the present disclosure may provide advanced user interface features, allowing users to create custom personalized canvases with data insights and charts obtained through a conversational interface. Users may further drill down to more detailed data, visualize information in tables, and resize and reposition charts, among other functionalities. Additionally, the present disclosure may utilize agentic workflow using artificial intelligence (AI)/machine learning (ML) models and knowledge graph, built using metadata and organization knowledge.

The present disclosure may provide advanced analytics, in addition to forecasting, anomaly detection or the like. The present disclosure may implement agentic AI models for generating recommendations after the response generation. For example, the user may ask a question like “show me the incident count by months for Application X’ which may return a line chart that is a timeseries of past incidents by month. A natural follow up question to said question may be to forecast the incidents in the coming months. The present disclosure may utilize data context and an analytical agent to provide the necessary predicted output to display in a new chart. Various analytic agents may support follow up of analytics questions.

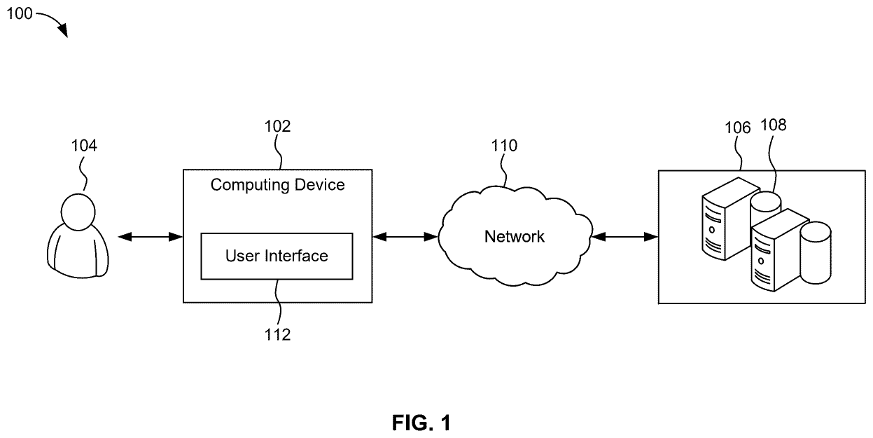

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes a computing device 102, a back-end system 106 and a network 110. In some examples, the computing device 102 are used by respective users 104 to log into and interact with the back-end system 106 and applications executing on the back-end system 106 according to implementations of the present disclosure.

In further detail, the user 104 may initiate a login request. The computing device 102 may redirect the user 104 to an identity provider (for example, an external service like, directory including one or more registered user's credentials). The identity provider may validate the user's 104 credentials against a directory. Upon successful verification, the identity provider may send a token (like a security assertion markup language (SAML) token or open authorization (OAuth)/OpenID connect token) back to the user interface 112. The successful verification or authentication may be confirmed by the computing device 102, which may include the user ID and session token. The token may be verified by the back-end system 106, thereby establishing a secure, authenticated session, via a JavaScript Object Notation (JSON) Web Token (JWT) or a secure session cookie.

After login, the computing device 102 may send an initial request to the back-end system 106, via the network 110. The initial request may include information like, but not limited to, user ID and session context, to fetch any prior interaction history (for example previous queries and responses) or saved visualizations (or canvas), thereby facilitating session continuity and personalization. In other words, the user 104 may enter a request (new query) (for example, natural language question, a search term, a selection of data parameters, or the like) through the user interface 112. The request may be captured by the user interface 112 and thereafter, the computing device 102 may pack the request query along with the current session context (including the prior interaction history/canvas data retrieved) and may send the user request to the back-end system 106 for further processing. In an example, the computing device 102 may send the user request by utilizing an application programming interface (API) call (for example, via Representational State Transfer (REST)). After the processing, the user interface 112 may receive the response, from the back-end system 106, as formatted data. The user interface 112 may render the response using visualization components (for example, charts, tables, graphs, or the like) for the user 104 to view and/or modify the response.

As shown in FIG. 1, the computing devices 102 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites (e.g., web applications executing on the back-end system 106), user devices (e.g., the computing device 102), and the back-end system 106. In some examples, the network 110 can be accessed over a wired and/or a wireless communications link. For example, mobile computing devices, such as smartphones can utilize a cellular network to access the network 110.

While only one back-end system 106 is shown in FIG. 1, there may be more than one back-end system 106, and each of the back-end systems 106 may include one or more server system 108. In some examples, the server system 108 hosts one or more computer implemented services that user 104 can interact with by using the computing device 102. For example, components of enterprise systems and applications can be hosted on one or more of the back-end system 106. In some examples, the back-end system 106 can be provided as an on-premises system that is operated by an enterprise or a third-party taking part in cross-platform interactions and data management. In some examples, the back-end system 106 can be provided as an off-premises system (e.g., cloud or on-demand) that is operated by an enterprise or a third party on behalf of an enterprise.

In some examples, the computing device 102 may include computer executable applications executed thereon. In some examples, the computing device 102 may include a web browser application executed thereon, which can be used to display one or more web pages of applications executing on the back-end system 106. In some examples, the computing device 102 can display one or more GUIs that enable the respective user 104 to interact with the back-end system 106. In accordance with implementations of the present disclosure, the back-end system 106 may host enterprise applications or systems that require data sharing and data privacy. In some examples, the computing device 102 can communicate with the back-end system 106 over the network 110.

In some implementations, the back-end system 106 can be implemented in a cloud environment. The back-end system 106 may include one or more server system (or server) 108. In the example of FIG. 1, the back-end system 106 can include various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 can be used for context-aware query interpretation using GenAI models. Various examples, depicting the context-aware query interpretation using GenAI models, are described in detail in conjunctions with figures below.

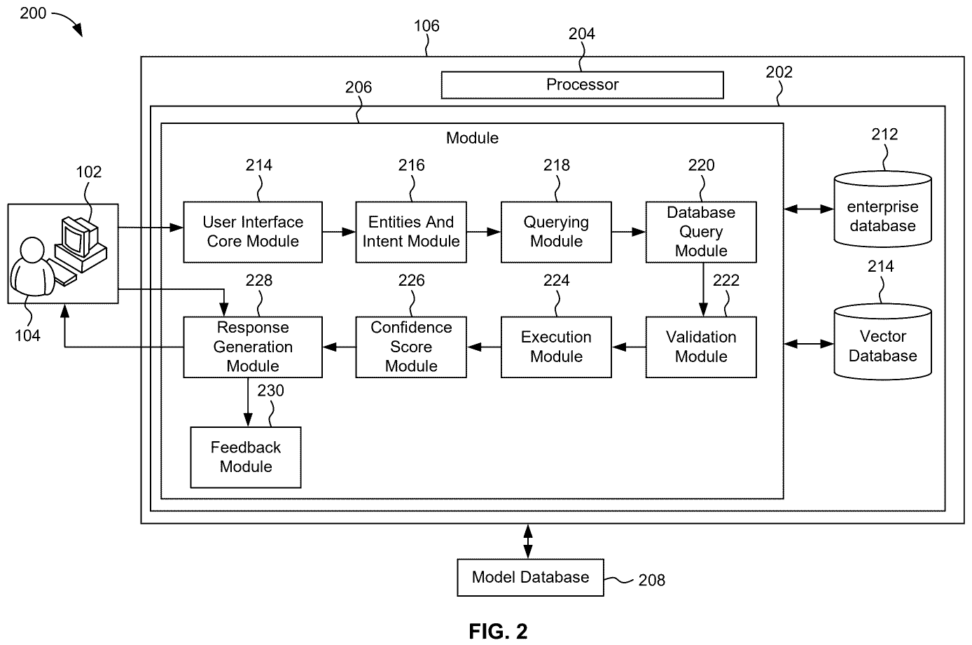

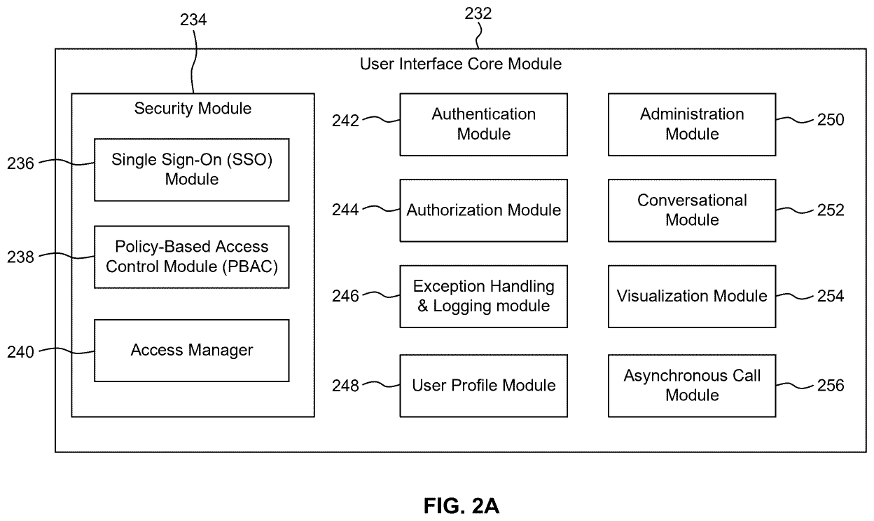

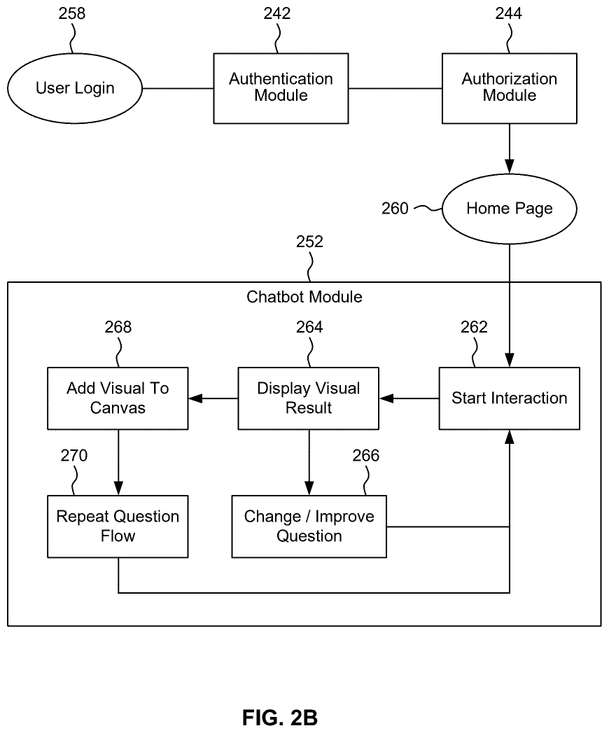

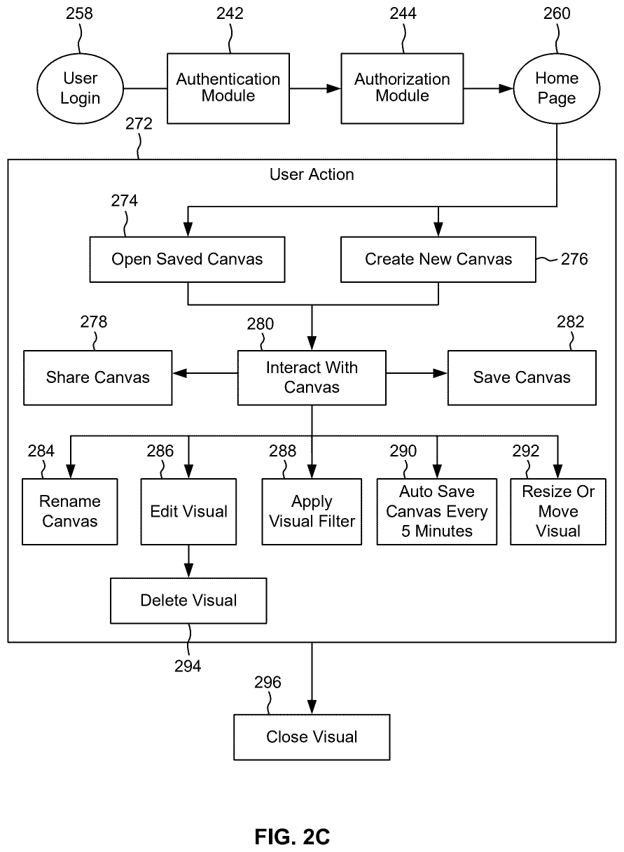

FIG. 2 illustrates an example architecture 200 of the back-end system 106 for context-aware query interpretation using GenAI models, in accordance with implementations of the present disclosure. The back-end system 106 may include one or more hardware processors 204, one or more non-transitory processor-readable medium (herein referenced as memory) 202, an enterprise database 212 and a vector database 214. The memory 202 may store processor-executable instructions to be executed by the one or more hardware processors 204. In the back-end system 106, the one or more hardware processors 204 may be communicably coupled with the one or more memory 202 and configured to execute the processor-executable instructions. In some examples, the one or more hardware processors 204 may include, but not limited to, microprocessors, microcomputers, hardware processors, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the one or more hardware processors 204 may be programmed to cooperate with non-transitory processor-readable instructions stored in one or more memory 202 for performing operations according to the present disclosure. The one or more memory 202 may be non-transitory or non-volatile medium, such as a magnetic disk or solid-state non-volatile memory or volatile medium such as Random Access Memory (RAM), and/or the like.

In some examples, the modules 206 may be in the form of programmable instructions executable by the one or more hardware processors 204. Further, the back-end system 106 may be communicatively coupled to a model database 208. The model database 208 may include one or more large language models (LLMs) (also be referenced to as GenAI models, foundation models, natural language processing (NLP) model, deep learning model, Graph neural network (GNN) and/or the like). In an implementation, the LLMs may include pre-trained LLMs or generated LLMs. The pre-trained LLMs may be general-purpose GenAI models like large deep learning neural networks, which may be trained using a broad range of generalized and unlabelled training data to perform one or more tasks, such as, human computer interactions (i.e., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or Artificial Intelligence (AI) models.

In the back-end system, the modules 206 may further include an user interface core module 232, an entities and intent module 216, a querying module 218, a database query module 220, a validation module 222, an execution module 224, a confidence score module 226, a response generation module 228 and a feedback module 230. The back-end system 106 may receive the request from the user 104 for generating a response corresponding to a domain. The request may include a natural language query. In an example, the natural language query may include information with regarding, a model type, a unique request identifier, a canvas identifier, and a user identifier. The request may be received as the API call, such a hypertext transfer protocol (HTTP POST). In an example implementation, the body of the request may include a JSON payload including the parameters. Moreover, the model type may specify the underlying model or domain-specific knowledge base which may process the request (for example, a finance model, a human resource (HR) model, or a specific LLM). The unique request identifier may refer to a unique key assigned to every individual request received by the back-end system 106. The unique request identifier may enable asynchronous processing, debugging, logging, and thereby, ensuring reliable communication. For example, the unique request identifier may be a unique string of characters used to track the lifecycle of the request from initiation to the response generation. The canvas identifier may include a unique key linking the current request to a specific, persistent visualization workspace or dashboard being actively viewed or edited by the user 104. The canvas identifier may enable the back-end system 106 to retrieve the session context, including applied filters, previous visualizations, and historical questions and answers, which may be necessary for multi-turn conversation (for example, if the user 104 asks “show it by region” the canvas identifier may specify the model what “it” is). Furthermore, the user identifier may refer to the key used to uniquely represent the authenticated and authorized individual user 104 making the request.

In an aspect, the request including the natural language query may include, a workflow request, and an action command. The natural language query may refer to a free-form textual input expressed in user language, intended for information retrieval or a factual answer concerning the enterprise data. The workflow request may refer to an instruction initiating a defined, multi-step process or sequence of operations within the enterprise environment (for example, initiating a multi-stage approval process). The action command may refer to a direct, imperative instruction intended to trigger a specific, singular operation or modification within the back-end system 106 or on the enterprise data (for example, “update record X”, “create report Y”, or the like). It may be appreciated that the user 104 is shown for illustration purposes only and that ‘user’ generating user queries (request) in accordance with the disclosed examples can also include applications being executed on the computing device 102 that automatically generate the natural language user queries without intervention from the human user 104. The user query may be a string of text formulated by the user 104 to express the required information. For instance, the user query may range from simple keyword searches phrased in a conversational manner (e.g., “What is the capital of France?”) to complex, multi-clause questions requiring nuanced understanding of context and semantics (e.g., “What are the long-term effects of this medication, considering the patient's history of heart disease?”). In addition to text initiated by the user 104, the user query may be implicitly generated from system events or derived from diverse data sources, encompassing textual input, uploaded files, documents, and multimedia content.

In the back-end system 106, the user interface core module 232 may receive the request. The further details of the user interface core module 232 are provided in conjunction with FIG. 2A. Thereafter, the entities and intent module 216 may identify one or more entities and an intent of the received request by parsing the natural language query (included in the request) using a hybrid vector model and graph model. Herein, the one or more entities may refer to structured data elements extracted from the structured or unstructured natural language query. In other words, the one or more entities may include specific, domain-relevant pieces of information (such as, values, objects, metrics, constraints, or the like) within the natural language query corresponding to fields, tables, or filters in the underlying data structure. For example, for a given natural language query “what is the average profit”, the one or entity may be “average profit”. In another example, for given natural language query “group the results by region”, the one or more entity may be “region”. Furthermore, the intent may refer to the user's 104 primary objective or the desired action associated with the natural language query. For example, given the natural language query “show revenue in the West region”, the intent may be “retrieve data”. In another example, given the natural language query “change this to a line chart”, the intent may be “modify visualization”.

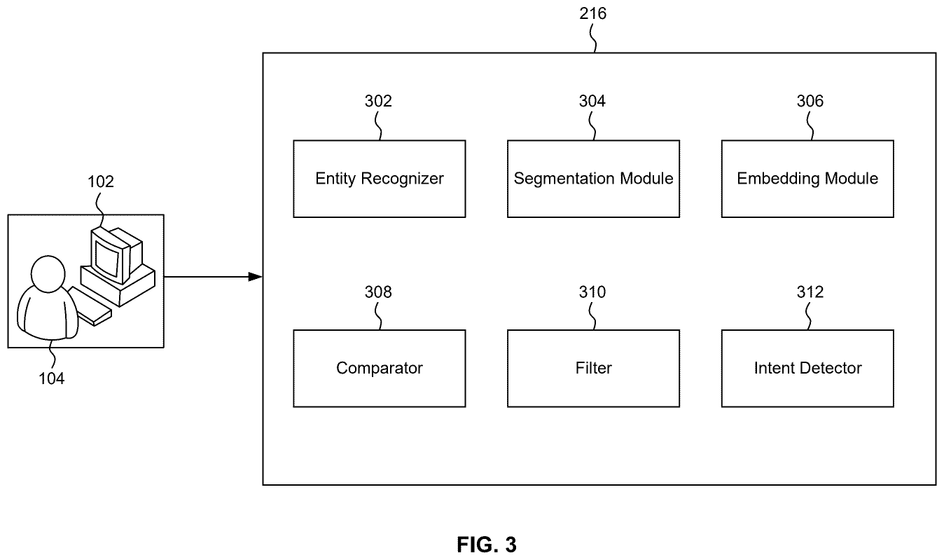

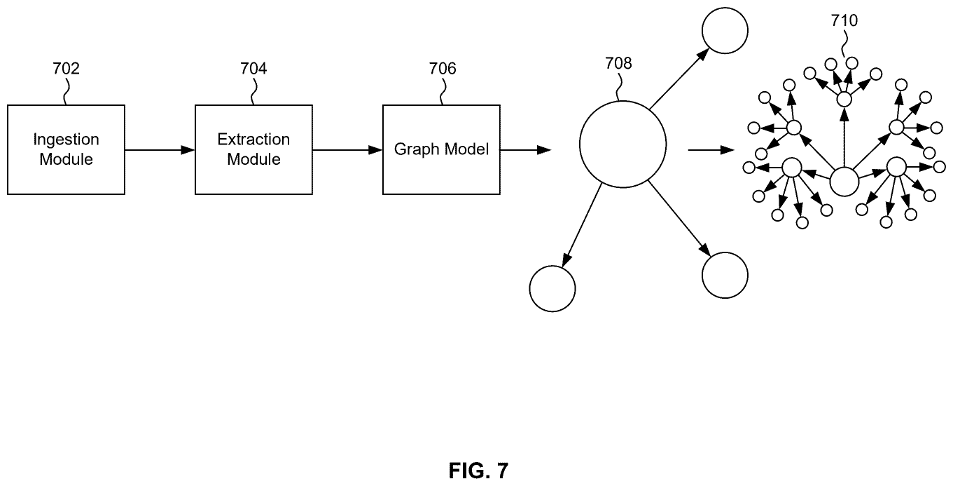

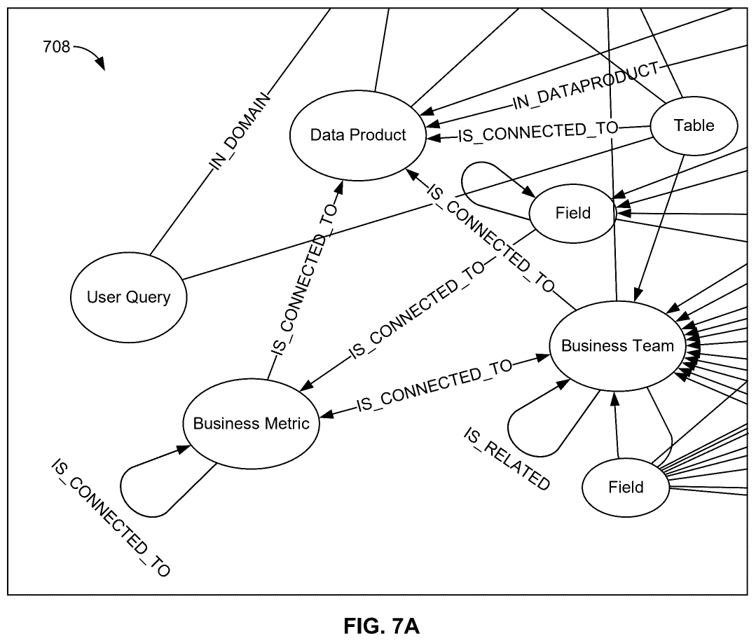

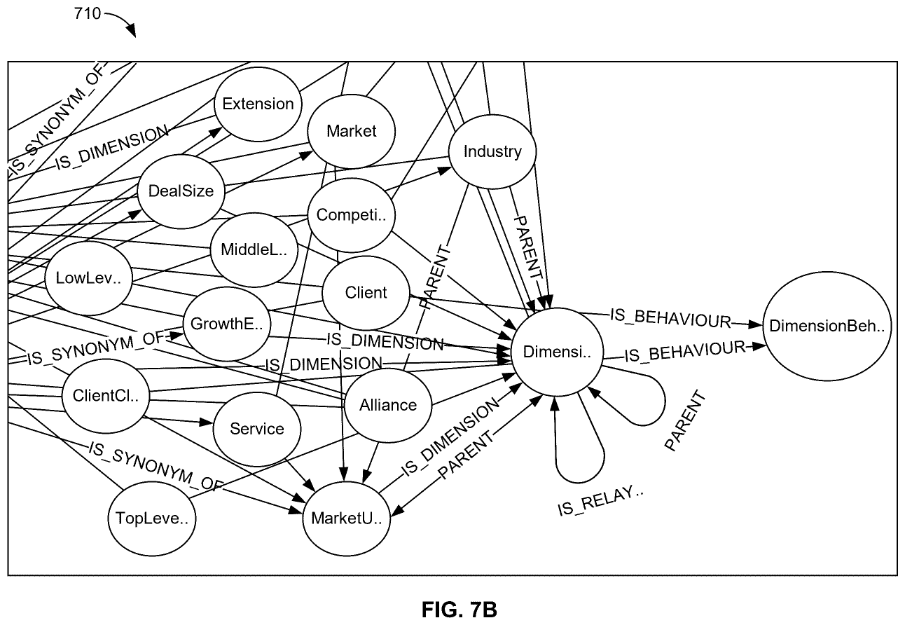

For example, the hybrid vector model and graph model may include the AI/ML models such as, Bidirectional Encoder Representations from Transformers (BERT), Word to Vector (Word2Vec), or transformer models. The entities and intent module 216 may access the hybrid vector model and graph model from the model database 208. The entities and intent module 216 by utilizing the hybrid vector model and graph model may execute techniques such as natural language processing (NLP) to parse the natural language query into corresponding semantic components. The entities and intent module 216 by utilizing the hybrid vector model and graph model may further transform the natural language query into a numerical vector representation (also called as embedding), thereby determining the semantic similarity and context of the words in the natural language query. In further detail, the hybrid vector model and graph model may provide structured, explicit relationships among one or more entities within the domain of the user 104. For instance, the entities and intent module 216, by using the hybrid vector model and graph model, may generate a knowledge graph where nodes may represent the one or more entities (for example, “product”, “region”, “sales metric”) and edges may represent relationships (for example, “is a part of”, “can be aggregated by”, or the like) (further details of knowledge graph generation are provided in conjunction with FIG. 7). In essence, the entities and intent module 216 by utilizing the hybrid vector model and graph model may identify the one or more entities and intent based on language and context of the natural language query. Also, the entities and intent module 216 by utilizing the hybrid vector model and graph model, may validate the one or more entities and intent by checking against the back-end system's 106 established data schema and relationships. Thus, the entities and intent module 216 may prevent generation of queries for non-existent metrics or invalid data structures, ensuring the resulting structured command is both semantically correct and executable. The further details of the entities and intent module 216 to identify one or more entities and the intent of the received request is described in conjunction with FIG. 3.

Moreover, the querying module 218 may determine candidate tables, fields, metrics, and dimensions relevant to the natural language query by querying the knowledge graph based on the identified entities and the intent. The knowledge graph may include, but not limited to, table metadata nodes, field nodes, dimension nodes, organization term nodes, organization metric nodes, synonym nodes, acronym nodes, user-query nodes, tip nodes, table-behavior nodes, and weighted relationships between each type of node. In further detail, the table metadata nodes may include entire database tables or logical data sources, in the enterprise database 212. The table metadata nodes may include metadata like table description, schema, and refresh cadence. For example, the table metadate node may be “sales transaction database”, which may serve the purpose of querying as identifying the primary data source to be queried. The field nodes may represent individual columns within the database table. The field nodes may be linked directly to table metadata nodes. For example, the field node may be “customer ID” linked to the table metadate node “sales transaction database”. The field nodes may serve the purpose of querying as identifying specific columns required for the statement. The dimension nodes may represent non-numeric, categorical columns used for grouping, filtering, or slicing data (for example, location, time, hierarchy). For example, the dimension nodes may include dimension column names and descriptions (from data catalog), in addition to data values (from the data tables). The organization term nodes may represent specific concepts, departments, or custom groupings used within the organization. The organization metric nodes may represent pre-calculated or commonly requested aggregate measures (the “facts” of the organization). The synonym nodes may represent alternative words or phrases that mean the same thing as a canonical schema element. The acronym nodes may represent common acronyms used in the organization. The user-query nodes may represent historical natural language queries or query segments submitted by users 104. The tip nodes may provide contextual advice, best practices, or suggested next steps related to a schema element or query type. The table-behavior nodes may capture observed usage patterns, such as the most common join path, common filters, or typical latency.

In further detail, the vector embeddings of the knowledge graph data (that is vector embeddings of the nodes and the edges) may be stored in the vector database 214. The querying module 218 may compare vector embeddings of the identified entities with the vector embeddings associated with nodes in the knowledge graph to obtain a first set of candidate nodes. The first set of the candidate nodes may include table metadata nodes, the field nodes, the dimension nodes, the organization term nodes, the organization metric nodes, the synonym nodes, the acronym nodes, the user-query nodes, the tip nodes, and the table-behavior nodes. The querying module 218 may compute the cosine similarity between the vector embeddings of the identified entities and the stored node vector embeddings. Nodes with a similarity score exceeding a pre-defined threshold may be obtained as the first set of the candidate nodes.

Additionally, the querying module 218 may obtain a second set of candidate nodes by determining weighted relationships in the knowledge graph derived from the first set of candidate nodes. Herein, the weighted relationships may include, but not limited to, the table-to-field relationships, the field-to-dimension relationships, the dimension-to-hierarchy relationships, the term-to-synonym relationships, the acronym-expansion relationships, the metric-definition relationships, and the table-behavior relationships. In further detail, the querying module 218 may execute techniques, such as graph traversal. The graph traversal technique may refer to the process of leveraging the structured relationships (edges) within the knowledge graph to expand the first set of semantically relevant nodes into a structurally complete query path. Thus, the querying module 218 may, in addition to the keyword matching, retrieve all linked components to build a valid database query. The querying module 218 may execute techniques such as, a limited-depth directed graph traversal starting from every node identified in the first set of candidate nodes. The graph traversal may follow the various weighted relationships (edges) which may define the data schema and organization logic. The weight on the relationship may represent the strength or commonality of the connection (for example, a common join path has a higher weight than a rarely used synonym). For example, with respect to the table-to-field relationships, if the first set of candidate nodes includes the table metadata node (for example, sales data), the querying module 218 may retrieve all linked field nodes (for example, date ID, product key, revenue amount, or the like), thereby, ensuring all columns from the relevant table.

Moreover, with respect to the dimension-to-hierarchy relationships, if the natural language query includes high level data (for example, “country”), the querying module 218 may retrieve all related child nodes (for example, state, city). Also, with respect to term-to-synonym relationships, if the first set of candidate nodes includes the term “staff count”, the querying module 218 may retrieve the canonical organization metric node (for example, total headcount). Further, with respect to the acronym-expansion relationships, if the natural language query includes “YTD” the querying module 218 may retrieve the expansion “Year to Date” and the associated metric-definition relationships. Also, with respect to the metric-definition relationships, if the metric node (for example, quarterly revenue), the querying module 218 may retrieve the constituent field nodes and the required aggregation logic (for example, sum of revenue field filtered by date key). With respect to the table-behavior relationships, if two table metadata nodes are retrieved (for example, sales and customers), the querying module 218 may identify the most frequent join key (for example, customer ID with a high weight).

Furthermore, the querying module 218 may merge the first set of candidate nodes with the second set of candidate nodes to generate a merged candidate-node set, by performing an union operation. Additionally, or alternatively, the querying module 218 may evaluate a strength of connections between the table metadata nodes, the field nodes, the metric nodes, and the dimension nodes by applying relationship-weight scoring to the merged candidate-node set. The querying module 218 may utilize graph-based scoring function to aggregate the weights of the edges. For instance, stronger (higher weighted) relationships (for example, frequently used joins, canonical schema definitions) may result in a higher path score, indicating a probable query path. After evaluation, the querying module 218 may filter nodes and relationships inaccessible to the user 104 by applying masking rules based on the user identifier. The masking rules may include, but not limited to a domain-level access, a dimension-level access, and a row-level security constraint. Each node and relationship in the merged candidate-node set may be is checked against the user's ID security profile, referencing the domain-level access, dimension-level access, and row-level security constraints defined in the initial authentication step. Moreover, the querying module 218 may filter the merged candidate-node set using an intent to align the merged candidate-node set with database operations indicated by the intent. For example, if the intent requires aggregation operations (for example, summation and average), the nodes which are neither metrics nor the fields defining a metric may be demoted or removed. Consequently, the querying module 218 may generate a refined set of candidate tables, candidate fields, candidate metrics, candidate dimensions by ranking the nodes in the filtered candidate-node set based on hybrid vector-similarity scores, graph-relationship scores, and intent-alignment scores.

Further, the database query module 220 may generate one or more candidate executable database queries based on the determined candidate tables, the fields, the metrics, and the dimensions relevant to the natural language query using a GenAI model. The database query module 220 may generate a structured prompt for the GenAI model based on the determined candidate tables, the fields, the metrics, and the dimensions relevant to the natural language query. Herein, the structured prompt may include, but not limited to, the natural-language query, the determined intent, the filtered candidate entities, security-filtered metadata, and examples of database query templates retrieved from the knowledge graph. For instance, for the natural language query “what is the total workforce by growth engines in 2024 in Argentina?”, the database query module 220 may retrieve the intent, along with the filtered candidate entities, from an intent detector 312 (in the entities and intent module 216 shown in FIG. 3). Moreover, the security-filtered metadata may include the schema context derived from the masked knowledge graph, thereby ensuring the GenAI model only generates the one or more candidate executable database query, using structurally valid and authorized filtered candidate entities. The security-filtered metadata may specify valid join paths (from table-behavior Nodes) and security constraints (for example, maximum returned rows). Additionally, or alternatively, the database query module 220 may retrieve examples of database query templates, which may be stored as user-query nodes or specific tip nodes. Thereafter, the database query module 220 may apply the structured prompt to the GenAI model to generate a one or more candidate executable database query. The one or more candidate executable database query may include one or more clauses like, but not limited to projection clauses, source clauses, join clauses, filtering clauses, grouping clauses, and ordering clauses. The clauses may serve as the core components of one or more candidate executable database query, which may define how data may be retrieved, filtered, grouped, and organized from the enterprise database 212. For instance, the projection clauses (for example “SELECT”) may include the columns or expressions which may be returned in the resulting one or more candidate executable database query. The projection clauses may determine the data to be projected to the user 104 (for example, SELECT column1, column2, FROM table name). The source clauses (for example, FROM) may include the table(s) or views from which the data may be retrieved. The source clauses may define the origin of the data for the one or more candidate executable database query (for example, FROM employee master data). The join clauses (for example, JOIN) may be used in conjunction with the source clauses (FROM) clause. The join clauses may combine rows from two or more tables based on a related column in between. For example, the join clauses INNER, LEFT, RIGHT, FULL, may specify the matching and non-matching of rows. The example of join clauses may be “FROM table1 JO IN table2 ON table1.column_id=table2.column_id”. The filtering clauses (for example WHERE) may apply conditions to individual rows, thereby filtering out the rows not meeting the specified criteria before any grouping or aggregation occurs. The example of the filtering clauses may be “WHERE year=2024 AND country=“Argentina””. The grouping clauses (for example, GROUP BY) may group records with the same values in a column and perform aggregate functions such as “sum”, “count”, or the like. The example of grouping clauses may be “GROUP BY organization unit”. The ordering clauses (for example, ORDER BY) may be used to sort query results in ascending or descending order, for example, ORDER BY column name DESC, another column ASC.

In an example, for the natural language query “what is the total workforce by growth engines in 2024 in Argentina?”, the database query module 220 may generate the one or more candidate executable database query as expressed below:

```
SELECT
  t1.unit AS “Growth Engine”,
  SUM(t1.fte_headcount) AS “Total Workforce”
FROM
  HR_Master_FTE AS t1
WHERE
  t1.reporting_year = 2024
  AND t1.country_code = ‘AR’ -- Mapped from ‘Argentina’
GROUP BY
  t1.business_unit
ORDER BY
  “Total Workforce” DESC;
```

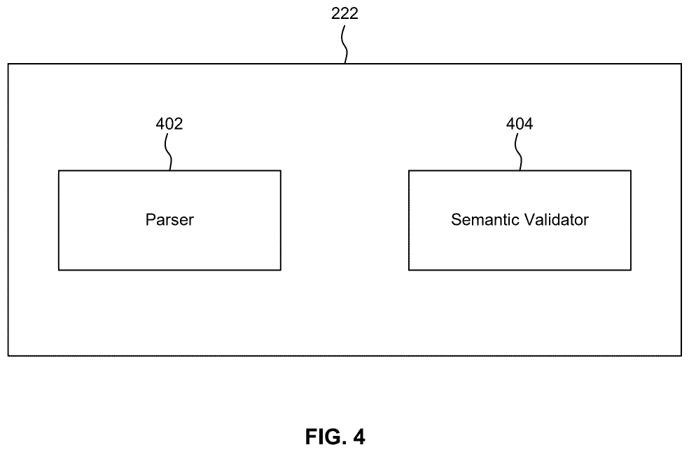

Further, the generated one or more candidate executable database query may be received by the validation module 222. The validation module 222 may validate the generated one or more candidate executable database query using a syntactic analysis model and iteratively refine the one or more candidate executable database query to generate a validated executable database query. The further details of the validation module 222 are described in conjunction with FIG. 4.

The validated one or more executable database query may be received by the execution module 224. The execution module 224 may generate output data corresponding to the natural language query. In further detail, the execution module 224, may utilize the API to connect to the target one or more structured data source (for example, database management system (DBMS), PostgreSQL store, or the like). The connection may require valid credentials (for example, username and password), a host address, and the specific one or more structured data source name Additionally, the execution module 224 may inspect the table metadata associated with the validated one or more executable database query to identify the target one or more structured data source. In an aspect, the execution module 224 may spilt the validated executable database query across more than one structured data source. Thereafter, the validated one or more executable database query may be executed on one or more structured data source by a database engine (not shown in FIG. 2) in the enterprise database 212, using a standard protocol (for example, Open Database Connectivity (ODBC)). Once the database engine executes the validated one or more executable database query, results may be fetched by execution module 224. Following the fetching of the results, the execution module 224 may generate output data corresponding to the natural language query, based on the results. The output data may be formatted by the execution module 224. For instance, the execution module 224 may convert the rows into a structured JSON array or a column-oriented format (like Apache Arrow) which may be compatible with the frontend visualization libraries (for example, Java Script library or open-source library) in the computing device 102.

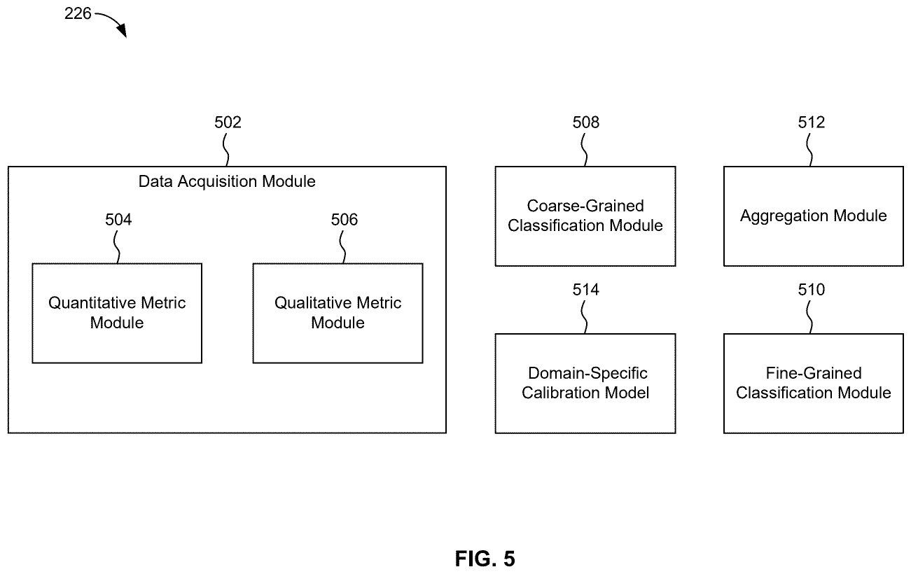

Moreover, the confidence score module 226 may compute a confidence score for the validated executable database query based on quantitative metrics and/or qualitative metrics using a classifier model. The confidence score may refer to a metric which aims to measure the confidence of the execution module 224 with respect to output data generation. In other words, the confidence score module 226 may include obtaining the quantitative metrics and the qualitative metrics, processing the quantitative metrics and the qualitative metrics the classifier model (in the model database 208), and normalizing the result into the final confidence score. The further details of the confidence score module 226 are provided in conjunction with FIG. 5.

After the computation of the confidence score, the response generation module 228 may generate a response to the natural language query based on the computed confidence score and the generated output data. The response may include the computed confidence score, and an explanation of reasoning performed in generating and validating the executable database query. Subsequently, the response generation module 228 may output the response on the user interface 112 of the user device 102.

In further detail, the response generation module 228 may receive the generated output data, the computed confidence score, intermediate artifacts, the validated executable database query, validation results, the quantitative metrics, the qualitative metrics, and reasoning information generated during the entity identification, the intent identification, the table determination, the one or more candidate executable database query generation, the validation of one or more candidate executable database query, and the confidence score computation. The response generation module 228 may personalize the response based on the user profile and the received request, by determining a user expertise level and a role associated with the user (may be retrieved from the user profile module 248). Moreover, the response generation module 228 may apply the data results, the confidence score, the intermediate artifacts, the reasoning information and features corresponding to the determined user expertise level and the role to the GenAI model (in the model database 208). Specifically, the response generation module 228 may construct a prompt for the GenAI model, said prompt may include the data results, the confidence score, the intermediate artifacts, the reasoning information and features corresponding to the determined user expertise level and the role. The response generation module 228 may apply to in-context learning by injecting the intermediate artifacts (for example, why a specific filter was chosen) into the prompt. In response to the prompt, the response generation module 228 may generate a natural-language explanation as an output of the GenAI model. The natural-language explanation may include a description of reasoning performed at each step of the entity identification, the intent identification, the table selection, the candidate query generation, the validation, and an interpretation of the confidence score, a summary in a non-technical language, and a detailed step-by-step technical explanation.

Furthermore, the response generation module 228 may generate one or more visual representations corresponding to the natural-language explanation using the GenAI model. For example, the one or more visual representation may include a chart type, such as, a bar chart and a line graph. In further detail, the response generation module 228 may analyse a natural language query format (for example, time-series vs. categorical) to select the chart type. The response generation module 228 may also generate a set of contextually relevant dynamic filter dimensions and hierarchy levels for performing one of a drill-down action and a drill-through action on the one or more visual representation. For instance, the response generation module 228 may identify the hierarchy levels (for example, if the user is viewing “country” the next hierarchy level is “state”). The response generation module 228 may generate the set of dynamic filter dimensions which may be contextually relevant, enabling the user interface 112 to render the drill-down and the drill-through buttons without requiring a new natural language query. Consequently, the response generation module 228 may generate the response including the one or more visual representation, the generated output data, the confidence score, the generated natural-language explanation, and the relevant dynamic filter dimensions.

In an aspect, after the response is displayed to the user 104 on the user interface 112, the feedback module 230 may receive user feedback on the response from the user 104. Herein, the user feedback may be based on a role of the user 104. The user feedback may include, but not limited to, a rating feedback and a feedback identifying one or more incorrect entity mapping, an incorrect table selection, and an incorrect database query structure. The feedback module 230 may validate the response, the computed confidence score, the generated output data, and the knowledge graph based on the received user feedback using the one or more GenAI models from the model database 208. The feedback module 230 may generate recommendations for the one or more GenAI models based on results of validation, using agentic AI models. Subsequently, the feedback module 230 may update the response, the computed confidence score, the generated output data and the knowledge graph based on the generated recommendations. The feedback module 230 may update the response by modifying the table metadata nodes, the field nodes, the dimension nodes, the organization term nodes, the organization metric nodes, the synonym nodes, the acronym nodes, the user-query nodes, the tip nodes, the table-behavior nodes, and/or the weighted relationships between each type of the node.

In another aspect, the response generation module 228 may validate the response by evaluating a consistency level between the generated response, the validated executable database query, the determined candidate tables, the fields, the metrics, the dimensions, and the knowledge-graph by applying rule-based validators, data-quality checks, and large language model (LLM) based semantic-consistency assessments. The response generation module 228 may apply the rule-based validators and the data-quality checks, by extracting numerical values and entities from the generated natural language explanation and comparing directly against the validated executable database query. For example, if response states “total revenue is $5M” but the validated executable database query states the “total revenue is $4.2M”, the response generation module 228 may raise a data mismatch error. For the LLM based semantic-consistency assessments, the LLM, in the model database 208 may perform semantic analysis on the generated response, the validated executable database query, the determined candidate tables, the fields, the metrics, the dimensions, and the knowledge-graph. The response generation module 228, by using the LLM, may verify if the terminology used in the response matches the canonical definitions stored in the knowledge graph, thereby ensuring domain-specific precision.

Furthermore, the response generation module 228 may detect one or more errors within the generated response based on results of validation. For instance, the one or more errors may include, but not limited to, hallucination (inventing data), semantic drift (misinterpreting a metric), or format violation (for example, “if response is not in valid format of JSON”). The detected one or more errors may include information such as the input prompt, the erroneous output, and the specific validation rule which was violated. After that, the response generation module 228 may determine one or more actions for rectifying the detected one or more errors by using the one or more GenAI models. Additionally, or alternatively the response generation module 228 may fine-tune the one or more GenAI models based on the determined one or more action. The fine-tuning may include updating model weights, error classifications, and semantic-alignment scores. The response generation module 228 may utilize techniques such as reinforcement learning from the feedback module 230 to update the model weights to reduce the probability of generating similar errors in the future.

FIG. 2A illustrates an example block diagram of the user interface core module 232, in accordance with implementations of the present disclosure. The user interface core module 232 may further include a security module 234, an authentication module 242, an authorization module 244, an exception handling and logging module 246, a user profile module 248, an administration module 250, a conversational module 252, a visualization module 254 and an asynchronous call module 256. The security module 234 may further include a single sign-on (SSO) module 236, a policy-based access control (PBAC) module 238 and an access manager 240. The security module 234 may be responsible for user access and rights management. The SSO module 236 may manage the initial authentication process, enabling the user 104 to access multiple independent applications in the back-end system 106 using a single set of credentials. The PBAC module 238 may define and enforce authorization rules based on policies in addition to specific user 104 roles. The PBAC module 238 may grant permission for accessing the back-end system 106 to the user 104 based on attributes like department, project, or access level, thereby providing fine-grained control over resources. The access manager 240 may be a specialized or proprietary module for custom access control logic or integration with the back-end system 106.

Moreover, the authorization module 244 may verify the user's 104 identity and confirm the security credentials provided by the SSO module 236. The authorization module 244 may determine actions permitted to the authenticated user to perform based on rules provided by the PBAC module 238. The exception handling & logging module 246 may capture runtime errors (exceptions) within the user interface 112 The exception handling & logging module 246 may generate detailed logs to facilitate debugging and monitoring of application (running in the back-end system 106) health. The detailed may be generated by utilizing a centralized logging service which may aggregate stack traces, user session IDs, and request metadata into an immutable audit store for real-time monitoring. Further, the user profile module 248 may manage user-specific data, settings, and preferences, querying a user access database (in the enterprise database 212) to retrieve authorized data scopes and personal configurations during the session initialization. The administration module 250 may provide elevated controls and tools for the user 104 (like, system administrators), such as user management, configuration changes, or policy updates. The conversational module 252 may be responsible for handling natural language interaction with the user 104. The visualization module 254 renders data into visual formats (charts, graphs, dashboards, or the like) for user 104 consumption. The visualization module 254 may process and displays the output response. Additionally, or alternatively, the user interface 112 may communicate with the back-end system 106 via the asynchronous call module 256, by utilizing techniques such as, asynchronous JavaScript and XML (AJAX), WebSockets, and/or a message queue. The asynchronous call module 256 may prevent the user interface 112 from freezing while waiting for resource-intensive operations, such as queries or responses.

FIG. 2B illustrates an example flow diagram depicting the workflow for the user 104 interacting with the back-end system 106, in accordance with implementations of the present disclosure. The user login 258 may imply that the user 104 may submit credentials (for example, username/password) or may receive the token from the SSO module 236. The authentication module 242 may validate the credentials, by checking against the identity provider (like active directory or a database). Upon successful validation by the authentication module 242, the session token (for example, JWT) may be issued to the user 104. The authorization module 244 may utilize the credentials to check access permissions. In other words, the authorization module 244 may check what resources and functions the user 104 may access (for example, via Role-Based Access Control (RBAC) or Policy-Based Access Control (PBAC)). Once authorized, the user interface 112 may load the main home page 260 view, which may include fetching and rendering the user interface components and initial data. Thereafter, the user interface 112 may start interaction 262 with the back-end system 106. The user interface 112, via the conversational module 252, may establish a connection (for instance, by using a WebSocket) or may prepare an API endpoint for communication with the back-end system 106. After that, the user 104 may input the request, for instance the request may include question (or query) in natural language. The user interface 112 may send the request to the back-end system 106 via the API call. Further, the result (or response) generated from the back-end system 106 after processing the request, may be displayed on the user interface 112 (references as “display visual result 264” in FIG. 2B). If the user 104 is satisfied with the result, the user may save the visualization included in the result. For instance, the resulting visualization may be added to the canvas 268. The user interface 112 may send the request to the back-end system 106 including the data query, visualization type, and user ID. The back-end system 106 may then store the result in the database for later retrieval.

Additionally, or alternatively, the user 104 may change and or modify the question 266 based on the last output or suggest modifications to the visualization (for example, “group this by month” or “show this data as a line graph”). The user interface 112 may send the modified question back to the back-end system 106 for re-processing. Moreover, after saving the visual or modifying the question, the user interface 112 may repeat the question flow 270 by returning to the start interaction 262 state, thereby maintaining the current session context so the conversational module 252 may process subsequent questions in relation to the previous ones.

FIG. 2C illustrates an example flow diagram depicting the user 104 action workflow on the user interface 112, in accordance with implementations of the present disclosure. After user login 258, which may be processed by the authentication module 242 and the authorization module 244. Upon receiving authorization, the home page 260 may be loaded, which may serve as the entry point to the core functionality of the back-end system 106. From the home page 260, the user 104 may enter the main user action 272 loop by selecting initiation paths, for instance, open saved canvas 274 or create new canvas 276. Thereafter, the user 104 may enter in an interact with canvas 280 state, and perform core operations, indicating a feature set for visualization development and sharing. The user 104 may edit visual 286 elements (for example, changing chart types or underlying data fields) or may apply visual filter 288 to refine the data displayed on the canvas. Moreover, the user 104 may control over the spatial organization through resize or move visual 292 operations, thereby enabling customized dashboard layouts. Additionally, or alternatively, the user 104 may perform actions like renaming canvas 284 and deleting visual 294 for managing the content and identity of the canvas. The user 104 may perform save canvas 282 action for persisting the current state of the canvas to the back-end system's 106 data store. In an aspect, the autosave 290 action may refer to an asynchronous operation which may provide data durability by automatically writing incremental changes to the back-end system 106, thereby mitigating data loss without requiring explicit user 104 input. Also, the user 104 may perform share canvas 278 action, which may include collaboration. The user interface 112 may generate a secure link or grant specific access rights to other authenticated users via the authorization module 244, thereby enabling the other authenticated users to view or edit the canvas. Consequently, the user action 272 loop may conclude when the user 104 selects close canvas 296, returning the user 104 to the home page 260.

FIG. 3 illustrates an example block diagram of the entities and intent module 216 to identify one or more entities and the intent of the received request, in accordance with implementations of the present disclosure. The entities and intent module 216 may further include an entity recognizer 302, a segmentation module 304, an embedding module 306, a comparator 308, a filter 310 and an intent detector 312. The entity recognizer 302 may authenticate the received request by dynamically masking nodes and relationships in the knowledge graph based on role associated with the user 104, domain access privileges, and dimension-level security profile. The entity recognizer 302 may retrieve the user's 104 profile (for example, regional manager-Argentina). After that, the entity recognizer 302, by utilizing the hybrid vector model and graph model, may filter the knowledge graph, which may serve as the map of entire available data stored in the enterprise database 212. The entity recognizer 302 may mask the nodes and edges representing data outside the user's 104 permission scope. For example, if the received request is “what is the total workforce by growth engines in 2024 in Argentina?”, the user 104 may be restricted to the “Argentina” region, therefore, the node for “Argentina” remains visible, but nodes for “France” or “USA” may be masked. Moreover, if the user's role is outside the purview of sensitive human resource (HR) data like “salary” the corresponding node in the knowledge graph may be masked. The node “total workforce (headcount), which is non-sensitive for the user's 104 role. remains visible. Subsequently, the entity recognizer 302 may identify the entities and the intent of the received request upon successful authentication of the received request.

Furthermore, the segmentation module 304 may classify the received request including the natural language query, into lexical units using a natural language processing (NLP) model (stored in the model database 208). The segmentation module 304, by utilizing the NLP model, may apply techniques such as, named entity recognition (NER) to process the natural language query. The segmentation module 304 may apply tokenization, lemmatization, and tagging to the natural language query, thereby segmenting the natural language query into units like words, phrases, and multi-word expressions. For example, for the natural language query “show total revenue for Q3 2024”, the lexical units may be “show”, “total”, “revenue”, “for” and “Q3 2024”. The lexical units may be received by the embedding module 306. The embedding module 306 may generate vector embeddings for the classified lexical units and the natural language query using the hybrid vector model and graph model, including an embedding model (stored in the model database 208). The embedding module 306, by utilizing the embedding model, may transform the lexical units into high-dimensional array of numbers, which may include the vector embeddings. Each dimension in the vector embeddings may represent a learned feature or aspect of the original data in the natural language query. The vector embeddings may capture the semantic meaning and context of the natural language query in a high-dimensional space.

Moreover, the comparator 308 may obtain candidate entities by comparing the generated vector embeddings with vector embeddings stored in the knowledge graph. The candidate entities may include table names, field names, the metrics, the dimensions, the dimension hierarchies, the synonyms, the acronyms, and the organization terms. The comparator 308 may compare by using techniques such as, approximate nearest neighbors (ANN) search based on cosine similarity. In further detail, the comparator 308 may determine cosine similarity (also known as the normalized dot product) by computing angular distance between the generated vector embeddings with vector embeddings stored in the knowledge graph. A smaller angle may indicate a higher semantic similarity, even if the exact wording differs. Thereafter, the filter 310 may filter the candidate entities by traversing relationships among the candidate entities, in the knowledge graph. Herein the relationships may include table-to-field relationships, dimension-to-hierarchy relationships, organization-term relationships, and synonym relationships. The filter may utilize the hybrid vector model and graph model to traverse the relationships among the candidate entities. Also the hybrid vector model and graph model may validate the connectivity within the knowledge graph schema. For example, with respect to table-to-field relationships, if the natural language query mentions “product” and “color” the filter 310, based on the knowledge graph, may confirms if the “color” is a valid field of the “product table”. Further, with respect to dimension-to-hierarchy relationships, if the natural language query mentions “city” the filter 310, based on the knowledge graph, may validate the hierarchy to “state” and “country”. Furthermore, with respect to organization-term relationships and synonym relationships, the candidate entity like “top-line” may be filtered and mapped to the canonical schema name “revenue” using the knowledge graph's synonym relationships. Thus, the filter 310 may output filtered candidates entities, by eliminating invalid or irrelevant matches.

Furthermore, the intent detector 312 may select the filtered candidate entities by integrating outputs from the hybrid vector model and graph model. The intent detector 312 may select based on semantic ranking of the candidate entities. Only filtered candidate entities which are both semantically relevant (high vector similarity) and structurally valid and authorized (exist in the masked knowledge graph) may be selected. After that, the intent detector 312 may generate an intent-classification representation of the natural language query using the large language model (LLM), from the model database 208. In further detail, the intent detector 312 may input the processed natural language query and the selected candidate entities in the LLM. The intent detector 312 may prompt the LLM with few-shot examples to generate a structured intent-classification representation, which may a structured object (for example, JSON, token sequence, or an Abstract Syntax Tree, or the like). The structured object may classify the entities into logical roles describing the action. Consequently, the intent detector 312 may determine an intent label by evaluating the generated intent-classification representation based on the filtered candidate entities. The evaluation may include, but not limited to, determining required database operations, grouping operations, filtering operations, and aggregation operations. In further detail, the intent detector 312 may determine required database operations by checking if the natural language query implies reading data, modifying data, or saving a view. The intent detector 312 may group operations by verifying if the natural language query desires a single number or a breakdown. The intent detector 312 may scan for entities tagged as dimensions in the knowledge graph. The intent detector 312 may filter operations by identifying entities which limit the scope of the data. The intent detector 312 may search for specific values (categorical) or ranges (numerical/temporal). The intent detector 312 may aggregate operations by checking how to handle the numerical data. The intent detector 312 may search for entities tagged as metrics or aggregation keywords (for example, “average”, “count”, “total”, or the like).

Based on the successful evaluation of the required database operations, grouping, filtering, and aggregation logic derived from the filtered candidate entities, the intent detector 312 may assign a specific intent label by mapping the confirmed logical structure to a predefined system command. The non-limiting examples of the specific intent label may include “search and retrieval”, “comparative analytics”, “export data command”, or the like. For instance, if the evaluation validates the need for a summation function (aggregation), a “group by” clause (grouping), and a “where” clause (filtering), the intent detector 312 may execute a lookup against the internal taxonomy and may assign the intent label such as “analytics aggregation query”. Conversely, the natural language query without metric entities, but including terms like “change chart to bar” may be mapped to “modify visualization” intent label. The assigned intent label may route the request to the appropriate backend service for execution.

FIG. 4 illustrates an example block diagram of the validation module 222 to validate the generated one or more candidate database query by the database query module 220, in accordance with implementations of the present disclosure. The validation module 222 may further include a parser 402 and a semantic validator 404. The parser 402 may generate an abstract syntax tree representation by parsing the one or more candidate executable database query. The parser 402 may also validate the abstract syntax tree representation for syntactic completeness level, a join completeness level, a filter applicability, and/or compliance with database-engine constraints. In further detail, the parser 402 may first read raw source code in the one or more candidate database query and convert the raw source code into a stream of tokens. The tokens may represent the fundamental building blocks, such as, keywords, identifiers, operators, or the like. The parser 402 may then process the stream of tokens and construct the abstract syntax tree representation. The processing may include applying the grammar rules of the programming language to determine the relationships between the tokens. The abstract syntax tree representation may refer to a hierarchical tree structure representing the grammatical parts of the one or more candidate database query. Furthermore, the parser 402 may validate the abstract syntax tree representation and may traverse the abstract syntax tree representation to check structural properties like, but not limited to, syntactic completeness level, a join completeness level, a filter applicability, and compliance with database-engine constraints. In further detail, the syntactic completeness level may refer to verify if the abstract syntax tree representation captures structural and grammatical elements of the raw source code as defined by the language's grammar, by omitting only inessential punctuation or grouping symbols. The syntactic completeness level may include structural traversal of the tree to ensure all expected nodes (for example, operators, variables, literals, or the like) and the corresponding hierarchical relationships are present and correctly formed. For example, an ADD node may have two child nodes representing the two terms to be added. The parser 402, by checking the join completeness level, may ensure that all necessary tables and the correct join conditions are specified and logically correct for the data requested. The join completeness level may include consulting the database's schema or a symbol table. The parser 402 may check that all columns referenced in the one or more candidate database query may be reached through the defined joins and that the unnecessary joins (for example, to link a filter condition to a selected column's table) are missing, which may result in an invalid one or more candidate database query or an error in data retrieval. Moreover, the filter applicability may include checking if all filter (or WHERE clauses) in the abstract syntax tree representation is logically valid and applicable to the data types and tables involved. The parser 402 may traverses the abstract syntax tree to the filter nodes and perform schema verification. The filter applicability may confirm if the columns referenced in the filter exist in the relevant tables and that the operations being performed (for example, comparison operators like =, >, <) are compatible with the data types of the columns (for example, avoiding comparing a string column with a date value using an incompatible operator). Further, the compliance with database-engine constraints may include checking if the one or more candidate database query adheres to the specific rules and limitations of the target database engine (for example, PostgreSQL, SQL Server, or the like). For instance, the parser 402 may ensure if operations (like INSERT or UPDATE) adhere to foreign key constraints. The compliance with database-engine constraints may also include checking if the data types and value ranges are within the database engine's or schema's limits.

Further, the semantic validator 404 may perform semantic validation on the one or more candidate executable database query by comparing referenced tables, the fields, the metrics, and the dimensions with the identified entities and a subgraph of the knowledge-graph referred during entity identification. The semantic validator 404 may retrieve the referenced tables, the fields, the metrics, and the dimensions from the abstract syntax tree. The subgraph of the knowledge graph may be a masked knowledge graph, which may be obtained from the entity recognizer 302 (in the entity and intent module 216). For example, if the abstract syntax tree references “table sales” but the subgraph of the knowledge graph node “table sales” was filtered out, then the validation fails. In another example, if the one or more candidate executable database query joins “table A” and “table B”, the semantic validator 404 may check the subgraph of the knowledge graph to verify if a valid table-behavior node or relationship edge exists. After that, the validation module 222 may validate the one or more candidate executable database query by comparing the one or more candidate executable database query with pre-determined syntactic conditions and semantic conditions. Herein, the syntactic conditions may include rules like “natural language queries must not contain DROP, DELETE, or UPDATE keywords” (read-only enforcement) or “limit clause is mandatory”. The semantic conditions may include rules like “aggregation queries must include a GROUP BY clause for every non-aggregated column in the SELECT list”. Based on the results of validation, the validation module 222 may generate validation-error information corresponding to the one or more candidate executable database query.

Additionally, or alternatively, the validation module 222 may iteratively re-generate the one or more executable database query using the GenAI model until one or more candidate executable database query meets the pre-determined syntactic conditions and the semantic conditions. In further detail, if the validation fails, the database query module 220 may utilize the error in the validation results, to re-generate the structured prompt for the GenAI model. In an example, the re-generated structured prompt may include, but not limited to, initial generated structured prompt, validation-failed one or more candidate executable database query and the validation error information. The iterative cycle may repeat until the one or more candidate executable database query passes all validation steps or a maximum retry limit is reached.

FIG. 5 illustrates an example block diagram of the confidence score module 226, in accordance with implementations of the present disclosure. The confidence score module 226 may further include a data acquisition module 502, a coarse-grained classification module 508, a fine-grained classification module 510, an aggregation module 512 and a domain-specific calibration model 514 (accessed from model database 208). The data acquisition module 502 may gather a comprehensive feature set representing the validated executable database query quality. The data acquisition module 502 may further include a quantitative metric module 504 and a qualitative metric module 506. The quantitative metric module 504 may obtain the quantitative metrics associated with the validated executable database query. The quantitative metrics may include, but not limited to, entity-detection rates, entity-type-mapping rates, counts of ambiguous entities, counts of missing entities, user-query matching scores, syntactic-validation results, and semantic-validation results. The entity-detection rates may refer to the percentage of entities identified (by the entity recognizer 302). The entity-type-mapping rates may refer to percentage of entities tagged as dimensions in the knowledge graph. The counts of ambiguous entities may refer to number of entities with multiple intent labels. The counts of missing entities may refer to number of entities determined as missing entities by the validation module 222, during validation of the one or more candidate executable database query. The user-query matching scores may be obtained by computing similarity scores (for example, cosine similarity score) between the user's 104 natural language query embeddings and the validated executable database query's vector representation (stored in the vector database 214). The syntactic-validation results, and semantic-validation results may be obtained from the validation module 222.

Moreover, the qualitative metric module 506 may obtain the qualitative metrics associated with the validated executable database query. The qualitative metrics may include, but not limited to, a table-selection reasoning, a field-selection reasoning, a filter-selection reasoning, a join-selection reasoning, and narrative semantic evaluations generated by the classifier model, such as light fine-tuned re-ranker model. In further detail, the qualitative metric module 506, by using the classifier model, may analyzes the relationship between the one or more entities of the received request (for example, “customer”) and the determined candidate tables. The qualitative metric module 506, by using the classifier model, may generate the narrative text explaining the reason for selection of a specific table (for example, table “customer master”) may be selected over other candidate tables (for example, table “prospects”). In further detail, qualitative metric module 506, by using the classifier model, may receive the natural language query and the metadata of all candidate tables identified. The qualitative metric module 506, by using the classifier model, may evaluate specific quantitative metrics, such as the percentage of detected entities and types which may map to each table. Subsequently, qualitative metric module 506, may generate a selected table reasoning, which may be a narrative string explaining the logical choice. For example, if the natural language query asks for “actual revenue”, the classifier model may generate text justifying the selection of “customer master” because the selected table may include confirmed transactions.

Furthermore, the qualitative metric module 506, by using the classifier model, may justify the selection of specific columns for projection or aggregation. The determined field (for example, “revenue amount”) may be validated for semantically matching the user's requested metric (for example, “sales”), in the natural language query. Moreover, for filter-selection reasoning, the qualitative metric module 506, by using the classifier model, may evaluate the WHERE clause. For instance, the qualitative metric module 506 may generate text confirming that the constraints in the validated executable database query (for example, date>“2023-01-01”) may reflect the temporal or categorical constraints in the text (for example, “after 2022”). For join-selection reasoning, the qualitative metric module 506, by using the classifier model, may analyze “join” conditions to ensure the path taken through the schema is valid and optimal. The qualitative metric module 506 may explain why a specific join key was used (for example, by referencing table-behavior nodes from the knowledge graph).

Further, the qualitative metric module 506 may parse and store the narrative semantic evaluations generated by the classifier model, as the qualitative metrics object (such as JavaScript Object Notation (JSON)). For example, the qualitative metric module 506 may parse the qualitative metrics object from the classifier model to extract the specific reasoning strings. The specific reasoning strings may be then tagged to the specific request ID and the validated executable database query ID. Moreover, the confidence score module 226 may retrieve the abstract syntax tree representation from the validation module 222 because the qualitative metrics object may be insufficient for extracting insights. The abstract syntax tree representation may enable the confidence score module 226 to capture analytics on top of the validated executable database query. Furthermore, the coarse-grained classification module 508 may perform a coarse-grained classification of the validated executable database query, by using the classifier model. The coarse-grained classification module 508 may input the quantitative metrics, the qualitative metrics into the classifier model, which may perform a verbalized confidence score classification reasoning over the inputs to output a categorical label, such as high, mid, low confidence. Additionally, or alternatively the fine-grained classification module 510 may input the abstract syntax tree representation into the classifier model, which may perform a fine-grained classification of individual nodes of the abstract syntax tree representation. The classifier model may review individual nodes (for example, a specific JOIN condition or WHERE clause) against the metadata reasoning to classify the correctness of the specific node. The fine-grained classification module 510 may output evaluation vectors. The evaluation vectors may refer to a multi-dimensional array representing the confidence levels of different parts of the validated executable database query structure (for example, join score: 0.9, filter score: 0.5, projection score: 0.95).

Moreover, the aggregation module 512 may aggregate the coarse-grained classification and the fine-grained classification into a raw confidence score. The raw confidence score may be passed through the domain-specific calibration model 514. The confidence score module 226 may adjust the raw confidence score to a final numerical confidence score within a predefined range (for example, 0.0 to 1.0) using the domain-specific calibration model 514. The domain-specific calibration model 514 may be trained by gathering historical query processing metrics and corresponding human-validated accuracy results, thereby predicting the confidence score with accuracy. For example, the domain-specific calibration model 514 may learn that when the “ambiguity count” is high, a “high confidence” label is actually only 60% accurate, and may adjust the final score downward accordingly.

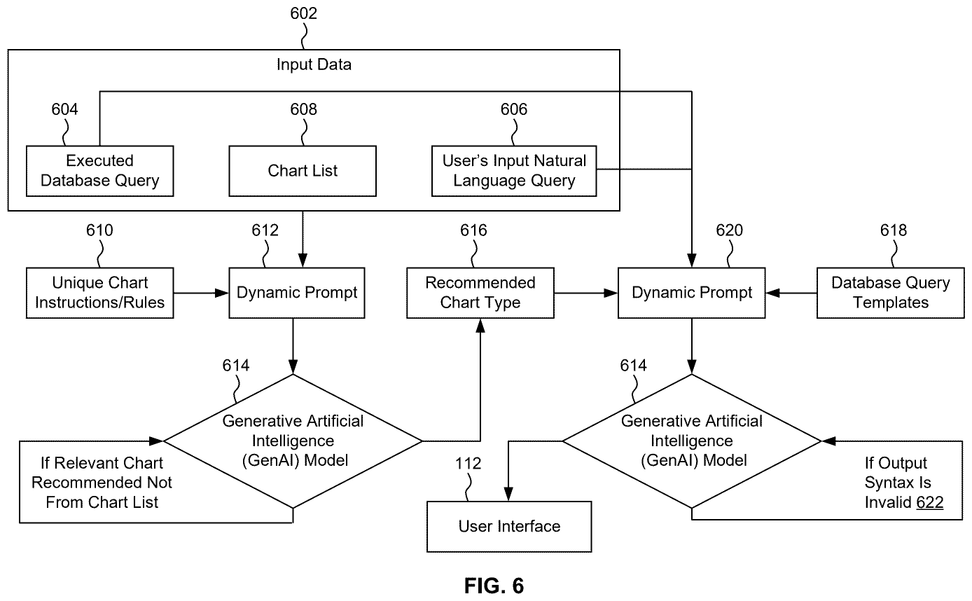

FIG. 6 illustrates an example flow diagram depicting the response generation process from the response generation module 228. The process may be initiated by receiving an input data 602, including executed database query 604, user's input natural language query 606, a chart list 608. The chart list 608 may include a predefined catalog of supported one or more visual representation (for example, bar, line, pie, or the like). The response generation module 228 may combine the input data 602 and specific unique chart instructions or rules 610 to generate a dynamic prompt 612. The dynamic prompt 612 may instruct the GenAI model on how to select the chart based on the data shape (for example, “use a line chart for time-series data”). The dynamic prompt 612 may be executed by the GenAI model 614, which may be accessed by the response generation module 228 from the model database 208. After said execution the GenAI model 614 may recommend a chart type 616 from the chart list 608. If the recommended chart type 616 is not present in the chart list 608, the response generation module 228 may trigger a feedback loop.

Moreover, the response generation module 228 may utilize examples of database query templates 618 (retrieved by the database query module 220), which may be specific to the recommended chart type 616, to generate a new dynamic prompt 620. The new dynamic prompt 620 may include the executed database query 604, the user's input natural language query 606 and the recommended chart type 616. The GenAI model 614 may process the new dynamic prompt 620 and generate a configuration code. The GenAI model 614 may generate the response based on the configuration code. The configuration code may refer to the machine-readable instructions required by the front-end user interface 112 to dynamically render the visualization. The configuration code may be a JSON structure which may define the exact appearance, data binding, and interactivity of the chart. In further detail, the GenAI model 614 may receive the database query template's 618 examples and instructions and may fill with the specific data and context from the user's input natural language query 606. Additionally, or alternatively, the GenAI model 614 may check if the output syntax is in JSON. If the output syntax is invalid 622, the output may enter the feedback loop to facilitate self-correction. Once output syntax is valid, the response generation module 228 may output the response on the user interface 112 of the user device 102.

FIG. 7 illustrates an example block diagram depicting the generation of the knowledge graph 710 by the entities and intent module 216, in accordance with implementations of the present disclosure. The entities and intent module 216 may further include an ingestion module 702 and an extraction module 704. The ingestion module 702 may determine a table metadata including, but not limited to, data product identifiers, table names, table descriptions, metric column names, metric column descriptions, field names, field descriptions, and table behavior classifications. The data product identifiers may refer to a key or name to categorizes a collection of related data assets (tables, dashboards, metrics) belonging to a specific domain (for example, DP_FIN_REVENUE, HR_MASTER_DATA, or the like). The table names may refer to the physical name of the table stored in the data warehouse or structured data source in the enterprise database 212 (for example, “fact monthly sales”, “dim employee hierarchy”, or the like). The table descriptions may refer to the summary of information included in the table. The metric column names may refer to the names of columns which may represent quantifiable key performance indicators (KPIs) (for example, “net revenue”, “FTE count”, “churn rate”, or the like). The metric column descriptions may include detailed explanations of the numerical values in the metric column (for example, “total gross sales in USD, calculated before discounts and taxes”). The field names may refer to physical names of non-metric columns, such as attributes, dimensions, or keys (for example, “customer ID”, “region code”, “fiscal year”, or the like). The field description may refer to definition of the specific data attribute to distinguish the field from similar fields (for example, the 3-letter ISO code for the country where the transaction originated). The table behavior classifications may specify how the table relates to others and how respective data may be aggregated (for example, “fact table”, “dimension table”, “aggregated summary”, or the like). The ingestion module 702 may determine the table metadata by scanning the enterprise database 212.

Further, the extraction module 704 may extract dimension values and dimension hierarchies for dimension columns from structured data sources (in the enterprise database 212) based on the determined table metadata. The extraction module 704 may query the structured data sources to extract the dimension values and dimension hierarchies (for example, specific country names in a “country” column). Additionally, the entities and intent module 216 may identify parent-child relationships within the data (for example, Region→Country→City). Moreover, the entities and intent module 216 may access the hybrid vector model and graph model 706, said hybrid vector model and graph model 706 may be a specific LLM from the model database 208. In further detail, the entities and intent module 216, by using the hybrid vector model and graph model 706, may map the determined table metadata along with the extracted dimension values and dimension hierarchies to a graph structure 708 (detailed representation is shown in FIG. 7A) where one or more entities may be represented by the nodes and logic may be represented by edges. The entities and intent module 216, by using the hybrid vector model and graph model 706, may create, but not limited to, table nodes and the field nodes connected by relationships, the dimension nodes including dimension values and hierarchy information connected to corresponding field nodes, the tip nodes connected to domain, data product, table, and the field nodes, and the table behaviour nodes indicating relational and aggregated fact table type connected to the table nodes.

Furthermore, the entities and intent module 216, by using the hybrid vector model and graph model 706, may perform actions on the table nodes, the field nodes, the dimension nodes, the organization term nodes, the organization metric nodes, the synonym nodes, the acronym nodes, the user-query nodes, the tip nodes, the table-behavior nodes. The actions may include, but not limited to, summarizing missing table descriptions and field descriptions, creating relationships between fields, creating groups of related fields, generating synthetic descriptions for dimensions with missing descriptions. Additionally, the hybrid vector model and graph model 706 may compute vector embeddings for nodes and edges of the graph structure 708, by using vectorization techniques and store the vector embeddings into the vector database 214.

The entities and intent module 216, by using the hybrid vector model and graph model 706, may further update the graph structure 708 to generate the knowledge graph 710 (detailed representation is shown in FIG. 7B). In further detail, the hybrid vector model and graph model 706 may enable the entities and intent module 216 to update the nodes by embedding organization information into each of the nodes by extracting organization terms, organization metrics, synonyms, and acronyms, creating the organization term nodes, the organization metric nodes, the synonym nodes, and the acronym nodes, creating relationships between the organization terms, creating connections between the organization terms and data products, and generating synthetic user-query-to-database sample pairs as the user-query nodes. Subsequently, the entities and intent module 216, by using the hybrid vector model and graph model 706, may generate the knowledge graph 710 based on the embedded organization information, the organization term nodes, the organization metric nodes, the synonym nodes, the acronym nodes, the relationships, the connections and the synthetic user-query-to-database sample pairs.

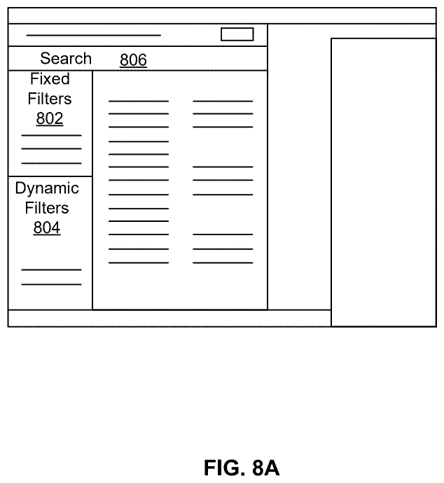

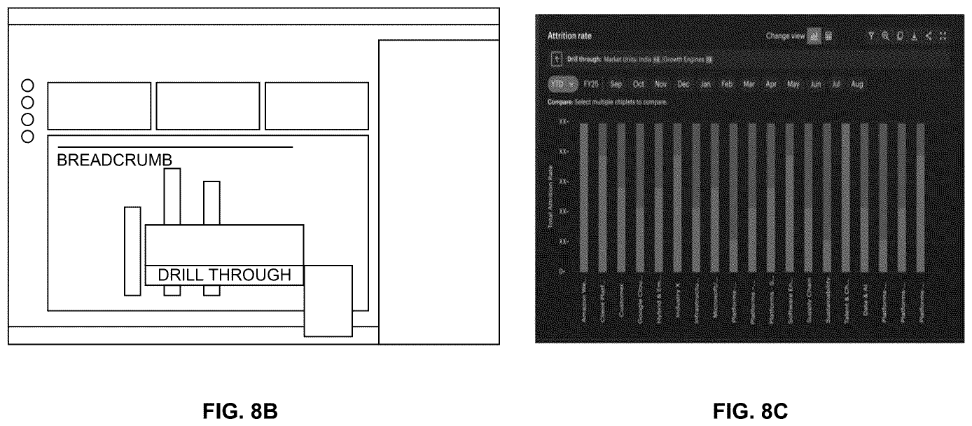

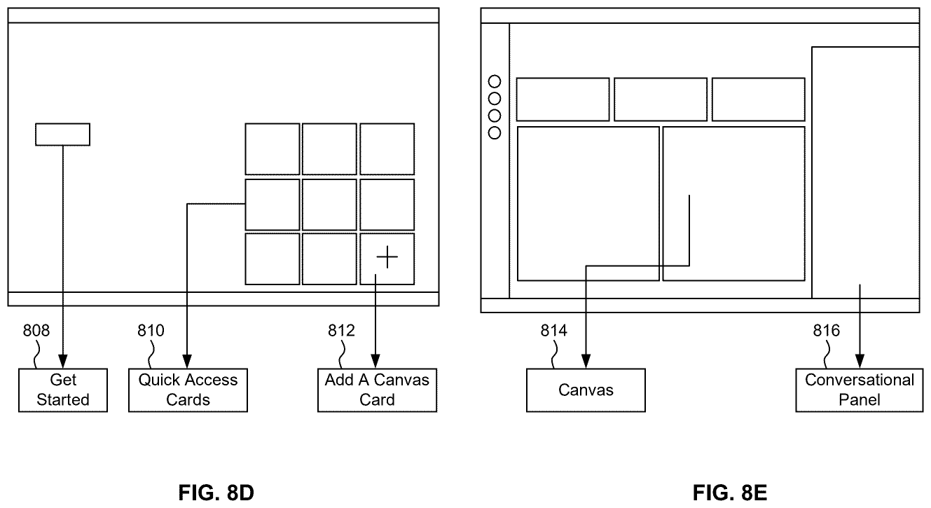

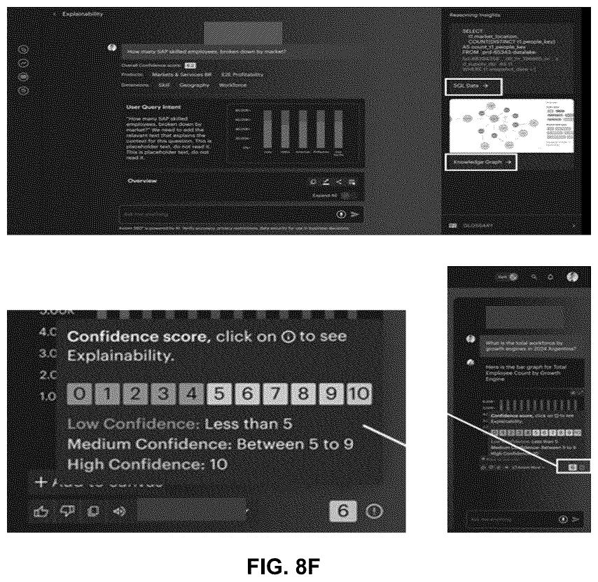

The FIG. 8A-8C depicts an example display of the output response on the user interface 112 of the user device 102, in accordance with implementations of the present disclosure. The back-end system 106 may determine the most relevant chart type (for example, bar, line, pie, or the like) based on the data's shape and the user's 104 request. The user interface 112 may receive a formatted response defining the chart configuration, thereby ensuring the response may be displayed as a visual result which may be added to the user's 104 canvas. In an example, the user interface 112 may include a card level filter panel to simplify large datasets with different consumption patterns. The filter may be categorized into fixed filters 802 and dynamic filters 804 (as shown in FIG. 8A). The dynamic filters 804 may be contextually generated based on the specific natural language query. The visual result on the user interface 112 may include visual filter indicators like, but not limited to filter icon, breadcrumbs and search panel 806 (as shown in FIG. 8A). The user 104 may click the filter icon (not shown in FIG. 8A) to open the specialized panel. The breadcrumbs icon (not shown in FIG. 8A) may include options, for example, Americas, growth market +3 to help the user 104 to track applied filters at a glance.

Moreover, an example visual representation of the drill-down action and the drill-through action is shown in FIG. 8B-8C. The drill down and drill through may be a functionality which may provide the user 104 a focused lens to view data at a granular level, based on the requirement with breadcrumbs 804 which may display selected dimension category and values. Once the breadcrumb shows the selection of filters, on click, the drill down view may show resultant breadcrumb. The tooltip with the drill through dropdown may provide the user 104 a detailed look at data, based on dimension category and values.

Further, an example landing page on the user interface 112 is shown in FIG. 8D. The landing page may include options such as, get started 808, quick access cards 810 and add a canvas card 812. The get started 808 option guide new users throughout the process. The quick access cards 810 option may include recently opened canvases to seamlessly resume the last session and/or start fresh with a blank canvas. The add a canvas card 812 option may enable the user 104 to start fresh with a blank canvas. Furthermore, as shown in FIG. 8E, there may be options such as a canvas 814 and a conversational panel 816. The canvas 814 may be a structured workspace to enable build data repositories for solutioning complex problems. The conversational panel 816 may enable the user 104 to ask questions and get in-line responses with data visualization. Moreover, as shown in FIG. 8F, confidence score and explainability may displayed below each response (as a numerical with the information icon next to it), on the user interface 112 in order to build trust and transparency with user 104. The confidence score may be aligned to a color code for low, medium, high confidence. On click of the information icon, the user 104 may see a full screen view of reasoning and explanation across different segments with confidence score for each. The final confidence score may be an aggregate of the scores of the individual components and may be rounded off to a single digit. Additionally, the validated database query (for example, Structured Query Language (SQL)) and knowledge graph may be displayed on the user interface 112 with the ability to click on the link and modify by the organization steward to get an accurate response.

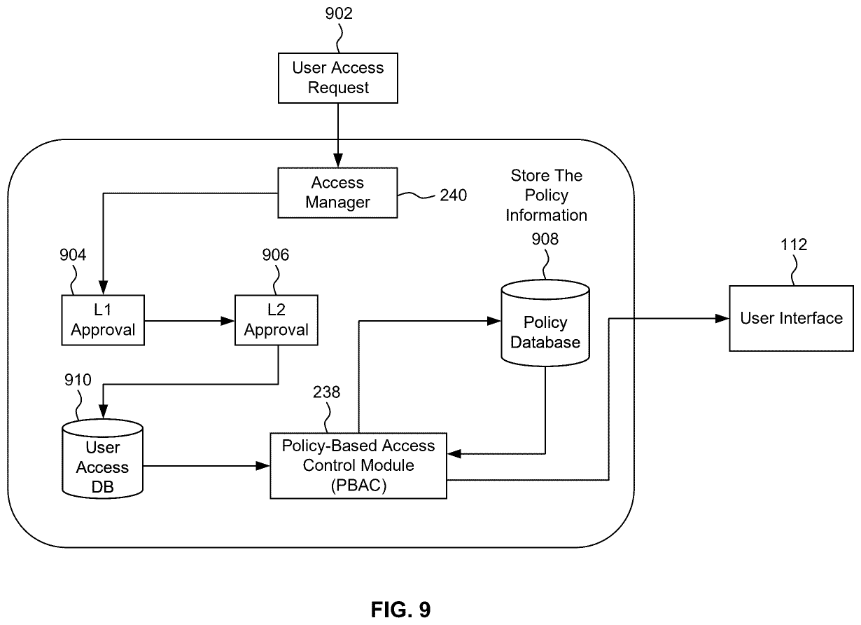

FIG. 9 illustrates an example flow diagram depicting the back-end system's 106 security framework, in accordance with implementations of the present disclosure. The user 104 may initiate an access request 902 to access the back-end system 106. The access request 902 may pass through a two-level approval process, that is level 1 approval 904 and level 2 approval 906. The level 1 and level 2 approvals may be managed by the access manager 240. Once approved, the access request 902 may further be authorized based on a user access database 910. The user access database 910 may store information for which the user 104 is authorized for. The PBAC module 238 may retrieve policy definitions from the policy database 908 and respond with the appropriate definition to the user interface 112.

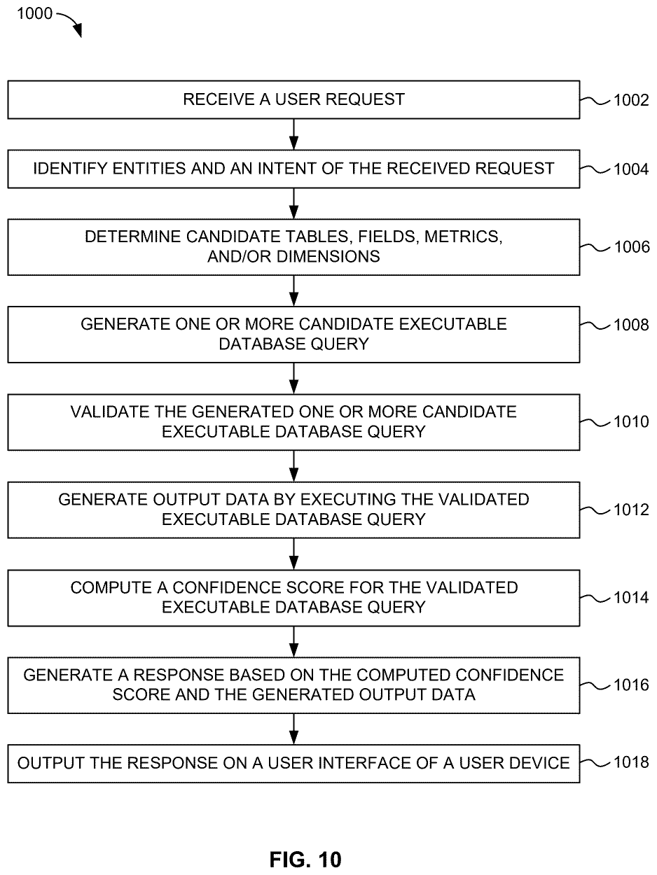

FIG. 10 illustrates a flow diagram of an example method 1000 for context-aware query interpretation using GenAI models, executed by the back-end system 106, in accordance with implementations of the present disclosure. In some examples, the method 1000 may be executed using the one or more processors 204 disclosed in related to FIGS. 1-9.

The method 1000 may include receiving 1002 a request for generating a response corresponding to a domain from a user. Herein, the request may include a natural language query.

The method 1000 may include identifying 1004 entities and an intent of the received request by parsing the natural language query using a hybrid vector model and graph model. Identifying 1004 entities and an intent of the received request may further include authenticating the received request by dynamically masking nodes and relationships in the knowledge graph based on a role associated with the at least one user, domain access privileges, and a dimension-level security profile. Moreover, the plurality of entities and the intent of the received request may be identified upon successful authentication of the received request. Further, the natural-language query may be classified into lexical units using a natural language processing model. Also, vector embeddings, may be generated, for the classified lexical units and the natural-language query using one or more embedding model. Furthermore, candidate entities may be obtained, by comparing the generated vector embeddings with vector embeddings stored in the knowledge graph. Herein, the candidate entities may include table names, field names, the metrics, the dimensions, the dimension hierarchies, the synonyms, the acronyms, and the organization terms. The candidate entities may be filtered by traversing relationships among the candidate entities, in the knowledge graph. The relationship may include table-to-field relationships, dimension-to-hierarchy relationships, organization-term relationships, and synonym relationships. The filtered candidate entities may be selected by integrating outputs from the hybrid vector model and graph model. An intent-classification representation of the natural-language query may be generated using a LLM. Additionally, an intent label may be determined by evaluating the generated intent-classification representation based on the filtered candidate entities. The evaluation may include determining required database operations, including, grouping operations, filtering operations, and aggregation operations.

The method 1000 may include determining 1006 candidate tables, fields, metrics, and/or dimensions relevant to the natural language query by querying a knowledge graph based on the identified entities and the intent. The knowledge graph may include table metadata nodes, field nodes, dimension nodes, organization term nodes, organization metric nodes, synonym nodes, acronym nodes, user-query nodes, tip nodes, table-behavior nodes, and/or weighted relationships between each type of node. Determining 1006 candidate tables, fields, metrics, and/or dimensions relevant to the natural language query may further include obtaining a first set of candidate nodes by comparing vector embeddings of the identified entities with vector embeddings associated with nodes in the knowledge graph. Herein, the first set of candidate nodes may include table metadata nodes, the field nodes, the dimension nodes, the organization term nodes, the organization metric nodes, the synonym nodes, the acronym nodes, the user-query nodes, the tip nodes, and the table-behavior nodes. Also, a second set of candidate nodes may be obtained by determining weighted relationships in the knowledge graph derived from the first set of candidate nodes. The weighted relationships may include, but not limited to, the table-to-field relationships, the field-to-dimension relationships, the dimension-to-hierarchy relationships, the term-to-synonym relationships, the acronym-expansion relationships, the metric-definition relationships, and the table-behavior relationships. Thereafter, the first set of candidate nodes may be merged with the second set of candidate nodes to generate a merged candidate-node set. A strength of connections between the table metadata nodes, the field nodes, the metric nodes, and the dimension nodes, may be evaluated, by applying relationship-weight scoring to the merged candidate-node set. Further, nodes and relationships inaccessible to the user, may be filtered, by applying masking rules based on the user identifier, wherein the masking rules comprise at least one of a domain-level access, a dimension-level access, and a row-level security constraint. Additionally, the merged candidate-node set may be filtered using the intent to align the merged candidate-node set with database operations indicated by the intent. The database operations may include, but not limited to, aggregation operations, grouping operations, filtering operations, and dimension-based operations. Subsequently, refined set of candidate tables, candidate fields, candidate metrics, and candidate dimensions may be generated by ranking the nodes in the filtered candidate-node set based on hybrid vector-similarity scores, graph-relationship scores, and intent-alignment scores.

The method 1000 may include generating 1008 one or more candidate executable database query based on the determined candidate tables, the fields, the metrics, and the dimensions relevant to the natural language query using one or more GenAI model. Generating 1008 one or more candidate executable database query may further include generating a structured prompt for the GenAI model based on the determined candidate tables, the fields, the metrics, and the dimensions relevant to the natural language query. Herein, the structured prompt may include the natural-language query, the determined intent, filtered candidate entities, security-filtered metadata, and examples of database query templates retrieved from the knowledge graph. Subsequently, the one or more candidate executable database query may be generated by applying the structured prompt to the GenAI model. The candidate executable database query may include projection clauses, source clauses, join clauses, filtering clauses, grouping clauses, and ordering clauses.

The method 1000 may include validating 1010 the generated one or more candidate executable database query using a syntactic analysis model. Moreover, the generated one or more candidate executable database query may be iteratively refined to generate a validated executable database query. The validation 1010 may further include generating an abstract syntax tree representation by parsing the one or more candidate executable database query and validating the abstract syntax tree representation for syntactic completeness level, a join completeness level, a filter applicability, and compliance with database-engine constraints. A semantic validation may be performed on the one or more candidate executable database query by comparing referenced tables, the fields, the metrics, and the dimensions with the identified entities and a subgraph of the knowledge-graph referred during entity identification. The one or more candidate executable database query may be validated by comparing the one or more candidate executable database query with pre-determined syntactic conditions and semantic conditions. After that, validation-error information, corresponding to the one or more candidate executable database query, may be generated, based on results of validation. Subsequently, the one or more executable database query may be iteratively re-generated, using the GenAI model until the one or more candidate executable database query meets the determined syntactic conditions and the semantic conditions.

The method 1000 may include generating 1012 output data corresponding to the natural language query by executing the validated executable database query on one or more structured data source.

The method 1000 may include computing 1014 a confidence score for the validated executable database query based on quantitative metrics and/or qualitative metrics using a classifier model. Computing 1014 the confidence score may further include obtaining the quantitative metrics associated with the validated executable database query. The quantitative metrics may include, but not limited to, entity-detection rates, entity-type-mapping rates, counts of ambiguous entities, counts of missing entities, user-query matching scores, syntactic-validation results, and semantic-validation results. Additionally, the qualitative metrics may be obtained, associated with the validated executable database query. The qualitative metrics may include, but not limited to, a table-selection reasoning, a field-selection reasoning, a filter-selection reasoning, a join-selection reasoning, and narrative semantic evaluations generated by the classifier model. Moreover, the validated executable database query may be converted into an abstract syntax tree (AST) representation. Furthermore, coarse-grained classification of the validated executable database query and fine-grained classification of individual nodes of the AST representation, may be performed, using the classifier model. Herein, the classifier model may receive as input the quantitative metrics, the qualitative metrics, and a knowledge graph context used during query generation. The coarse-grained classification and the fine-grained classification may be aggregated into a raw confidence score. Subsequently, the raw confidence score may be adjusted to a final numerical confidence score within a predefined range using a domain-specific calibration model trained on historical query processing metrics and corresponding human-validated accuracy results.

The method 1000 may include generating 1016 a response to the natural language query based on the computed confidence score and the generated output data. The response may include the computed confidence score, and an explanation of reasoning performed in generating and validating the executable database query. Generating 1016 the response may further include receiving the generated output data, the computed confidence score, intermediate artifacts, the validated executable database query, validation results, the quantitative metrics, the qualitative metrics, and reasoning information generated during an entity identification, the intent identification, the table determination, the one or more candidate executable database query generation, the validation of the one or more candidate executable database query, and the confidence score computation. Further, a user expertise level and a role associated with the user, may be determined, based on a user profile and the received request. Furthermore, the data results, the confidence score, the intermediate artifacts, the reasoning information and features corresponding to the determined user expertise level and the role to the GenAI model may be applied. A natural-language explanation may be generated as an output of the GenAI model. Herein, the natural-language explanation may include a description of reasoning performed at each step of the entity identification, the intent identification, the table selection, the candidate query generation, the validation, and an interpretation of the confidence score, a summary in a non-technical language, and a detailed step-by-step technical explanation. Thereafter, one or more visual representation corresponding to the natural-language explanation may be generated using the GenAI model. Also, a set of contextually relevant dynamic filter dimensions and hierarchy levels for performing one of a drill-down action and a drill-through action on the one or more visual representation may be generated. Subsequently, the response may be generated. The response may include, but not limited to, the one or more visual representation, the generated output data, the confidence score, the generated natural-language explanation, and the relevant dynamic filter dimensions.

The method 1000 may include outputting 1018 the response on a user interface of a user device 102.

Implementations of the present disclosure provide technical advancements in the context of context-aware query interpretation using GenAI models. For instance, the present disclosure may enable users to determine detailed insights through natural language queries on structured and un-structured data stored in the enterprise database. The present disclosure may utilize knowledge graph as the source of the data knowledge from which the user query intent may be converted to a structured language (such as, SQL). In the present disclosure, the entities and intent module, by using the graph model, may generate the knowledge graph using the meta data of the data products stored in the enterprise database. Additionally, the knowledge graph may be generated by using user input repository of common terms, organization terms, acronyms, synonyms of terms used and sample questions and the corresponding queries answering said sample questions.

In the present disclosure, by structuring metadata and organization knowledge in the hierarchical and interconnected manner, the knowledge graph may facilitate efficient and accurate data queries, supporting the continuous improvement of GenAI's query capabilities. The knowledge graph may organize information in a manner that enhances the accuracy and relevance of queries over time through continuous feedback. Each node, in the knowledge graph may include text embeddings which may in turn improve hybrid Search, allowing simultaneous execution of graph traversals and cosine similarity operations on different vector indexes within the knowledge graph elements.

Moreover, the present disclosure may utilize the dynamic prompts in an agentic workflow to process the natural language and provide a response for as well as additional components like confidence score, explainability and context based dynamic filter selection.

Further, the present disclosure may provide data security by masking the appropriate domains/tables or fields as defined by policy for a specific user based on the role. For instance, the querying module may filter nodes and relationships, in the knowledge graph, inaccessible to the user by applying masking rules based on the user identifier. Thus, the masking may ensure that the back-end system may respond back to the user query only for data/information the user is allowed to access. Herein, the masking mechanism may facilitate obtaining cross domain insights in a single dashboards instead of requiring multiple dashboards and aggregate the information.

Furthermore, in the present disclosure, the validation module may ensure that the executable database query generated by the database query module using the GenAI model is both syntactically correct and semantically valid. The validation module may also ensure that the executable database query is executable against the specific database schema. In this way, the validation module may prevent hallucinated queries (for example, querying non-existent columns) from reaching the enterprise database.

Moreover, in the present disclosure, the qualitative metric module may provide transparency on how the response is generated, by providing an explanation to the end user. The qualitative metric module, by using the classifier model, may provide a detailed explanation with details for each of the intermediate steps for the user. The explainability may be provided both in real-time as well as may be retrieved by the user on demand anytime in the future. Additionally, for each response generated the confidence score module may generates the confidence score. The confidence score may denote the accuracy level of the generated response. In further detail, said explanation may be a high level description of reason behind the confidence score. The explanation may be used by the user to decide if the response is accurate or needs to be validated further before using the response to draw conclusions in decision making. Additionally, or alternatively the explanation may include details of the outcomes of each of the steps in the agentic workflow. The explanation may provide details of the reasoning and the decision flow to arrive at the responses and may be technical in content. The explanation may rely on synthesizing the logs from each of the steps in the agentic workflow to arrive at the combined explanation.

The present disclosure may provide a collaborative workspace by sharing a set of canvas charts/dashboards with other users. Thereby, enabling users to work collaboratively on single dashboard. Additionally, the collaborative workspace may ensure that the necessary data security rules and policies are adhered to. Appropriate warning and error messages are provided to both the users should any organization policy be violated.

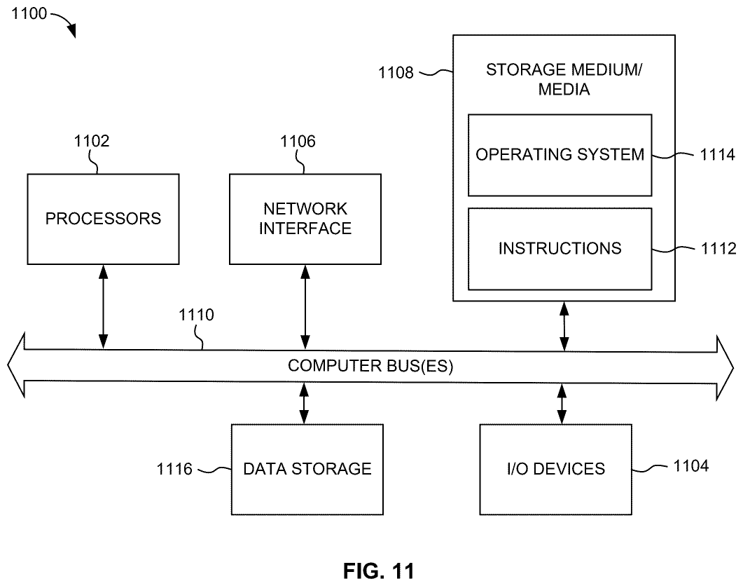

FIG. 11 illustrates a computer system 1100 that may be used to implement the back-end system 106 disclosed in the example environment 100 of FIG. 1. for context-aware query interpretation using GenAI models, in accordance with implementations of the present disclosure. More particularly, computing machines such as desktops, laptops, smartphones, tablets, and wearables which may be used to implement the tasks that may have the structure of the computer system 1100. The computer system 1100 may include additional components not shown and that some of the process components described may be removed and/or modified. In another example, a computer system 1100 may be deployed on external-cloud platforms such as cloud, internal corporate cloud computing clusters, organizational computing resources, and/or the like.

The computer system 1100 includes processor(s) 1102, such as a central processing unit, ASIC or another type of processing circuit, input/output devices 1104, such as a display, mouse keyboard, etc., a network interface 1106, such as a Local Area Network (LAN), a wireless 502.11x LAN, a 3G or 4G mobile WAN or a WiMax WAN, and a computer-readable medium 1108. Each of these components may be operatively coupled to a bus 1110. The computer-readable medium 1108 may be any suitable medium that participates in providing instructions to the processor(s) 1102 for execution. For example, the computer-readable medium 1108 may be non-transitory or non-volatile medium, such as a magnetic disk or solid-state non-volatile memory or volatile medium such as RAM. The instructions or modules stored on the computer-readable medium 1108 may include machine-readable instructions 1112 executed by the processor(s) 1102 that cause the processor(s) 1102 to perform the methods and functions of the system for context-aware query interpretation using GenAI models.

The system 106 may be implemented as software stored on a non-transitory processor-readable medium and executed by the processors 1102. For example, the computer-readable medium 1108 may store an operating system 1114, such as MAC OS, MS WINDOWS, UNIX, or LINUX, and code for the system. The operating system 1114 may be multi-user, multiprocessing, multitasking, multithreading, real-time, and the like. For example, during runtime, the operating system 1114 is running and the code for the system is executed by the processor(s) 1102.

The computer system 1100 may include a data storage 1116, which may include non-volatile data storage. The data storage 1116 stores any data used or generated by the system.

The network interface 1106 connects the computer system 1100 to internal systems for example, via a LAN. Also, the network interface 1106 may connect the computer system 1100 to the Internet. For example, the computer system 1100 may connect to web browsers and other external applications and systems via the network interface 1106.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (for example, a field programmable gate array (FPGA) or an application specific integrated circuit (ASIC).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship between client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A system comprising:
a processor; and
a memory communicably coupled to the processor, wherein the memory comprises processor-executable instructions which, when executed by the processor, cause the processor to:
receive a request for generating a response corresponding to a domain from at least one user, wherein the request comprises a natural language query;
identify a plurality of entities and an intent of the received request by parsing the natural language query using a hybrid vector and graph model;
determine at least one of candidate tables, fields, metrics, and dimensions relevant to the natural language query by querying a knowledge graph based on the identified plurality of entities and the intent, wherein the knowledge graph comprises at least one of table metadata nodes, field nodes, dimension nodes, organization term nodes, organization metric nodes, synonym nodes, acronym nodes, user-query nodes, tip nodes, table-behavior nodes, and weighted relationships between each type of node;
generate at least one candidate executable database query based on the determined candidate tables, the fields, the metrics, and the dimensions relevant to the natural language query using at least one Generative Artificial Intelligence (GenAI) model;
validate the generated at least one candidate executable database query using a syntactic analysis model and iteratively refine the at least one candidate executable database query to generate a validated executable database query;
generate output data corresponding to the natural language query by executing the validated executable database query on at least one structured data source;
compute a confidence score for the validated executable database query based on at least one of quantitative metrics and qualitative metrics using a classifier model;
generate a response to the natural language query based on the computed confidence score and the generated output data, wherein the response comprises the computed confidence score, and an explanation of reasoning performed in generating and validating the executable database query; and
output the response on a user interface of a user device.

2. The system of claim 1, wherein the processor is further to:
receive user feedback on the response, outputted on the user interface, from the at least one user, wherein the user feedback is based on a role of the at least one user, wherein the user feedback comprises a rating feedback and a feedback identifying at least one incorrect entity mapping, an incorrect table selection, and an incorrect database query structure;
validate the response, the computed confidence score, the generated output data, and the knowledge graph based on the received user feedback using a plurality of GenAI models;
generate a plurality of recommendations for the at least one GenAI model based on results of validation, using agentic AI models; and
update the response, the computed confidence score, the generated output data and the knowledge graph based on the generated plurality of recommendations by modifying at least one of the table metadata nodes, the field nodes, the dimension nodes, the organization term nodes, the organization metric nodes, the synonym nodes, the acronym nodes, the user-query nodes, the tip nodes, the table-behavior nodes, and the weighted relationships between each type of the node.

3. The system of claim 1, wherein the processor is further to:
validate the generated response by evaluating a consistency level between the generated response, the validated executable database query, the determined candidate tables, the fields, the metrics, the dimensions, and the knowledge-graph by applying rule-based validators, data-quality checks, and large language model (LLM) based semantic-consistency assessments;
detect a plurality of errors within the generated response based on results of validation;
determine at least one action for rectifying the detected plurality of errors by using the plurality of Generative Artificial Intelligence (GenAI) models; and
fine-tune the at least one GenAI model based on the determined at least one action, wherein the fine-tuning comprises updating model weights, error classifications, and semantic-alignment scores.

4. The system of claim 1, wherein to identify the plurality of entities and the intent of the received request by parsing the natural language query using the hybrid vector and graph model, the processor is further to:
authenticate the received request by dynamically masking nodes and relationships in the knowledge graph based on a role associated with the at least one user, domain access privileges, and a dimension-level security profile; and
identify the plurality of entities and the intent of the received request upon successful authentication of the received request.

5. The system of claim 1, wherein to identify the plurality of entities and the intent of the received request by parsing the natural language query using the hybrid vector and graph model, the processor is further to:
classify the natural-language query into a plurality of lexical units using a natural language processing model;
generate a plurality of vector embeddings for the classified plurality of lexical units and the natural-language query using at least one embedding model;
obtain a plurality of candidate entities by comparing the generated plurality of vector embeddings with vector embeddings stored in the knowledge graph, wherein the plurality of candidate entities comprise table names, field names, the metrics, the dimensions, the dimension hierarchies, the synonyms, the acronyms, and the organization terms;
filter the plurality of candidate entities by traversing relationships among the plurality of candidate entities, in the knowledge graph, wherein the relationship comprises table-to-field relationships, dimension-to-hierarchy relationships, organization-term relationships, and synonym relationships;
select the filtered plurality of candidate entities by integrating outputs from the hybrid vector model and graph model;
generate an intent-classification representation of the natural-language query using a LLM; and
determine an intent label by evaluating the generated intent-classification representation based on the filtered plurality of candidate entities, wherein the evaluation comprises at least one of determining required database operations, wherein the required database operation comprises at least one of grouping operations, filtering operations, and aggregation operations.

6. The system of claim 1, wherein to determine the at least one of candidate tables, the fields, the metrics, and the dimensions relevant to the natural language query by querying the knowledge graph based on the identified plurality of entities and the intent, the processor is to:
obtain a first set of candidate nodes by comparing vector embeddings of the identified plurality of entities with vector embeddings associated with nodes in the knowledge graph, wherein the first set of candidate nodes comprise table metadata nodes, the field nodes, the dimension nodes, the organization term nodes, the organization metric nodes, the synonym nodes, the acronym nodes, the user-query nodes, the tip nodes, and the table-behavior nodes;
obtain a second set of candidate nodes by determining weighted relationships in the knowledge graph derived from the first set of candidate nodes, wherein the weighted relationships comprise at least one of the table-to-field relationships, the field-to-dimension relationships, the dimension-to-hierarchy relationships, the term-to-synonym relationships, the acronym-expansion relationships, the metric-definition relationships, and the table-behavior relationships;
merge the first set of candidate nodes with the second set of candidate nodes to generate a merged candidate-node set;
evaluate a strength of connections between the table metadata nodes, the field nodes, the metric nodes, and the dimension nodes by applying relationship-weight scoring to the merged candidate-node set;
filter nodes and relationships inaccessible to the at least one user by applying masking rules based on the user identifier, wherein the masking rules comprise at least one of a domain-level access, a dimension-level access, and a row-level security constraint;
filter the merged candidate-node set using the intent to align the merged candidate-node set with database operations indicated by the intent, wherein the database operations comprise at least one of aggregation operations, grouping operations, filtering operations, and dimension-based operations; and
generate refined set of candidate tables, candidate fields, candidate metrics, and candidate dimensions by ranking the nodes in the filtered candidate-node set based on hybrid vector-similarity scores, graph-relationship scores, and intent-alignment scores.

7. The system of claim 1, wherein to generate the at least one candidate executable database query based on the determined candidate tables, the fields, the metrics, and the dimensions relevant to the natural language query using the at least one GenAI model, the processor is to:
generate a structured prompt for the GenAI model based on the determined candidate tables, the fields, the metrics, and the dimensions relevant to the natural language query, wherein the structured prompt comprises the natural-language query, the determined intent, filtered candidate entities, security-filtered metadata, and examples of database query templates retrieved from the knowledge graph; and
generate the at least one candidate executable database query by applying the structured prompt to the GenAI model, wherein the candidate executable database query comprises projection clauses, source clauses, join clauses, filtering clauses, grouping clauses, and ordering clauses.

8. The system of claim 1, wherein to compute the confidence score for the validated executable database query based on the at least one of quantitative metrics and the qualitative metrics using the classifier model, the processor is to:
obtain the quantitative metrics associated with the validated executable database query, wherein the quantitative metrics comprise at least one of entity-detection rates, entity-type-mapping rates, counts of ambiguous entities, counts of missing entities, user-query matching scores, syntactic-validation results, and semantic-validation results;
obtain the qualitative metrics associated with the validated executable database query, wherein the qualitative metrics comprise at least one of a table-selection reasoning, a field-selection reasoning, a filter-selection reasoning, a join-selection reasoning, and narrative semantic evaluations generated by the classifier model;
convert the validated executable database query into an abstract syntax tree (AST) representation;
perform at least one of coarse-grained classification of the validated executable database query and fine-grained classification of individual nodes of the AST representation using the classifier model, wherein the classifier model receives as input the quantitative metrics, the qualitative metrics, and a knowledge graph context used during query generation,
aggregate the coarse-grained classification and the fine-grained classification into a raw confidence score; and
adjust the raw confidence score to a final numerical confidence score within a predefined range using a domain-specific calibration model trained on historical query processing metrics and corresponding human-validated accuracy results.

9. The system of claim 1, wherein to generate the response to the natural language query based on the computed confidence score and the generated output data, the processor is to:
receive at least one of the generated output data, the computed confidence score, intermediate artifacts, the validated executable database query, validation results, the quantitative metrics, the qualitative metrics, and reasoning information generated during an entity identification, the intent identification, the table determination, at least one candidate executable database query generation, the validation of at least one candidate executable database query, and the confidence score computation;
determine a user expertise level and a role associated with the at least one user based on a user profile and the received request;
apply the data results, the confidence score, the intermediate artifacts, the reasoning information and features corresponding to the determined user expertise level and the role to the GenAI model;
generate a natural-language explanation as an output of the GenAI model, wherein the natural-language explanation comprises a description of reasoning performed at each step of the entity identification, the intent identification, the table selection, the candidate query generation, the validation, and an interpretation of the confidence score, a summary in a non-technical language, and a detailed step-by-step technical explanation;
generate at least one visual representation corresponding to the natural-language explanation using the GenAI model;
generate a set of contextually relevant dynamic filter dimensions and hierarchy levels for performing one of a drill-down action and a drill-through action on the at least one visual representation; and
generate the response comprising the at least one visual representation, the generated output data, the confidence score, the generated natural-language explanation, and the relevant dynamic filter dimensions.

10. The system of claim 1, wherein the processor is to:
determine a table metadata comprising data product identifiers, table names, table descriptions, metric column names, metric column descriptions, field names, field descriptions, and table behavior classifications;
extract dimension values and dimension hierarchies for dimension columns from a plurality of structured data sources based on the determined table metadata;
create at least one of table nodes and the field nodes connected by relationships, the dimension nodes comprising dimension values and hierarchy information connected to corresponding field nodes, the tip nodes connected to domain, data product, table, and the field nodes, and the table behavior nodes indicating relational and aggregated fact table type connected to the table nodes;
perform a plurality of actions on the table nodes, the field nodes, the dimension nodes, the organization term nodes, the organization metric nodes, the synonym nodes, the acronym nodes, the user-query nodes, the tip nodes, the table-behavior nodes using the at least one large language model (LLM), wherein the plurality of actions comprise summarizing missing table descriptions and field descriptions, creating relationships between fields, creating groups of related fields, generating synthetic descriptions for dimensions with missing descriptions, and computing vector embeddings for nodes;
update the nodes by embedding organization information into each of the nodes by extracting organization terms, organization metrics, synonyms, and acronyms, creating the organization term nodes, the organization metric nodes, the synonym nodes, and the acronym nodes, creating relationships between the organization terms, creating connections between the organization terms and data products, and generating synthetic user-query-to-database sample pairs as the user-query nodes; and
generate the knowledge graph based on the embedded organization information, the organization term nodes, the organization metric nodes, the synonym nodes, the acronym nodes, the relationships, the connections and the synthetic user-query-to-database sample pairs.

11. A method comprising:
receiving, by a processor, a request for generating a response corresponding to a domain from at least one user, wherein the request comprises a natural language query;
identifying, by the processor, a plurality of entities and an intent of the received request by parsing the natural language query using a hybrid vector and graph model;
determining, by the processor, at least one of candidate tables, fields, metrics, and dimensions relevant to the natural language query by querying a knowledge graph based on the identified plurality of entities and the intent, wherein the knowledge graph comprises at least one of table metadata nodes, field nodes, dimension nodes, organization term nodes, organization metric nodes, synonym nodes, acronym nodes, user-query nodes, tip nodes, table-behavior nodes, and weighted relationships between each type of node;
generating, by the processor, at least one candidate executable database query based on the determined candidate tables, the fields, the metrics, and the dimensions relevant to the natural language query using at least one Generative Artificial Intelligence (GenAI) model;
validating, by the processor, the generated at least one candidate executable database query using a syntactic analysis model, and iteratively refine the at least one candidate executable database query to generate a validated executable database query;
generating, by the processor, output data corresponding to the natural language query by executing the validated executable database query on at least one structured data source;
computing, by the processor, a confidence score for the validated executable database query based on at least one of quantitative metrics and qualitative metrics using a classifier model;
generating, by the processor, a response to the natural language query based on the computed confidence score and the generated output data, wherein the response comprises the computed confidence score, and an explanation of reasoning performed in generating and validating the executable database query; and
outputting, by the processor, the response on a user interface of a user device.

12. The method of claim 11, further comprising:
receiving, by the processor, user feedback on the response outputted on the user interface from the at least one user, wherein the user feedback is based on a role of the at least one user, wherein the user feedback comprises a rating feedback and a feedback identifying at least one incorrect entity mapping, an incorrect table selection, and an incorrect database query structure;
validating, by the processor, the response, the computed confidence score, the generated output data, and the knowledge graph based on the received user feedback using a plurality of Generative Artificial Intelligence (GenAI) models;
generating, by the processor, a plurality of recommendations for the at least one GenAI model based on results of validation using agentic AI models; and
updating, by the processor, the response, the computed confidence score, the generated output data and the knowledge graph based on the generated plurality of recommendations by modifying at least one of the table metadata nodes, the field nodes, the dimension nodes, the organization term nodes, the organization metric nodes, the synonym nodes, the acronym nodes, the user-query nodes, the tip nodes, the table-behavior nodes, and the weighted relationships between each type of the node.

13. The method of claim 11, further comprising:
validating, by the processor, the generated response by evaluating a consistency level between the generated response, the validated executable database query, the determined candidate tables, the fields, the metrics, the dimensions, and the knowledge-graph by applying rule-based validators, data-quality checks, and large language model (LLM) based semantic-consistency assessments;
detecting, by the processor, a plurality of errors within the generated response based on results of validation;
determining, by the processor, at least one action for rectifying the detected plurality of errors by using the plurality of Generative Artificial Intelligence (GenAI) models; and
fine-tuning, by the processor, the at least one GenAI model based on the determined at least one action, wherein the fine-tuning comprises updating model weights, error classifications, and semantic-alignment scores.

14. The method of claim 11, wherein identifying the plurality of entities and the intent of the received request by parsing the natural language query using the hybrid vector and graph model comprises:
classifying, by the processor, the natural-language query into a plurality of lexical units using a natural-language-processing model;
generating, by the processor, a plurality of vector embeddings for the classified plurality of lexical units and the natural-language query using at least one embedding model;
obtaining, by the processor, a plurality of candidate entities by comparing the generated plurality of vector embeddings with vector embeddings stored in the knowledge graph, wherein the plurality of candidate entities comprise table names, field names, the metrics, the dimensions, the dimension hierarchies, the synonyms, the acronyms, and the organization terms;
filtering, by the processor, the plurality of candidate entities by traversing relationships in the knowledge graph among the plurality of candidate entities, wherein the relationship comprises table-to-field relationships, dimension-to-hierarchy relationships, organization—term relationships, and synonym relationships;
selecting, by the processor, the filtered plurality of candidate entities by integrating outputs from the hybrid vector model and graph model;
generating, by the processor, an intent-classification representation of the natural-language query using a LLM; and
determining, by the processor, an intent label by evaluating the generated intent-classification representation based on the filtered plurality of candidate entities, wherein the evaluation comprises at least one of determining required database operations, wherein the required database operation comprises at least one of grouping operations, filtering operations, and aggregation operations.

15. The method of claim 11, wherein determining the at least one of candidate tables, the fields, the metrics, and the dimensions relevant to the natural language query by querying the knowledge graph based on the identified plurality of entities and the intent comprises:
obtaining, by the processor, a first set of candidate nodes by comparing vector embeddings of the identified plurality of entities with vector embeddings associated with nodes in the knowledge graph, wherein the first set of candidate nodes comprise table metadata nodes, the field nodes, the dimension nodes, the organization term nodes, the organization metric nodes, the synonym nodes, the acronym nodes, the user-query nodes, the tip nodes, and the table-behavior nodes;
obtaining, by the processor, a second set of candidate nodes by determining weighted relationships in the knowledge graph derived from the first set of candidate nodes, wherein the weighted relationships comprise at least one of the table-to-field relationships, the field-to-dimension relationships, the dimension-to-hierarchy relationships, the term-to-synonym relationships, the acronym-expansion relationships, the metric-definition relationships, and the table-behavior relationships;
merging, by the processor, the first set of candidate nodes with the second set of candidate nodes to generate a merged candidate-node set;
evaluating, by the processor, a strength of connections between the table metadata nodes, the field nodes, the metric nodes, and the dimension nodes by applying relationship-weight scoring to the merged candidate-node set;
filtering, by the processor, nodes, and relationships inaccessible to the at least one user by applying masking rules based on the user identifier, wherein the masking rules comprise at least one of a domain-level access, a dimension-level access, and a row-level security constraint;
filtering, by the processor, the merged candidate-node set using the intent to align the merged candidate-node set with database operations indicated by the intent, wherein the database operations comprise at least one of aggregation operations, grouping operations, filtering operations, and dimension-based operations; and
generating, by the processor, refined set of candidate tables, candidate fields, candidate metrics, and candidate dimensions by ranking the nodes in the filtered candidate-node set based on hybrid vector-similarity scores, graph-relationship scores, and intent-alignment scores.

16. The method of claim 11, wherein generating the at least one candidate executable database query based on the determined candidate tables, the fields, the metrics, and the dimensions relevant to the natural language query using the at least one GenAI model comprises:
generating, by the processor, a structured prompt for the GenAI model based on the determined candidate tables, the fields, the metrics, and the dimensions relevant to the natural language query, wherein the structured prompt comprises the natural-language query, the determined intent, filtered candidate entities, security-filtered metadata, and examples of database query templates retrieved from the knowledge graph; and
generating, by the processor, the at least one candidate executable database query by applying the structured prompt to the GenAI model, wherein the candidate executable database query comprises projection clauses, source clauses, join clauses, filtering clauses, grouping clauses, and ordering clauses.

17. The method of claim 11, wherein computing the confidence score for the validated executable database query based on the at least one of quantitative metrics and the qualitative metrics using the classifier model comprises:
obtaining, by the processor, the quantitative metrics associated with the validated executable database query, wherein the quantitative metrics comprise at least one of entity-detection rates, entity-type-mapping rates, counts of ambiguous entities, counts of missing entities, user-query matching scores, syntactic-validation results, and semantic-validation results;
obtaining, by the processor, the qualitative metrics associated with the validated executable database query, wherein the qualitative metrics comprise at least one of a table-selection reasoning, a field-selection reasoning, a filter-selection reasoning, a join-selection reasoning, and narrative semantic evaluations generated by the classifier model;
converting, by the processor, the validated executable database query into an abstract syntax tree (AST) representation;
performing, by the processor, at least one of coarse-grained classification of the validated executable database query and fine-grained classification of individual nodes of the AST representation using the classifier model, wherein the classifier model receives as input the quantitative metrics, the qualitative metrics, and a knowledge graph context used during query generation,
aggregating, by the processor, the coarse-grained classification and the fine-grained classification into a raw confidence score; and
adjusting, by the processor, the raw confidence score to a final numerical confidence score within a predefined range using a domain-specific calibration model trained on historical query processing metrics and corresponding human-validated accuracy results.

18. The method of claim 11, wherein generating the response to the natural language query based on the computed confidence score and the generated output data comprises:
receiving, by the processor, at least one of the generated output data, the computed confidence score, intermediate artifacts, the validated executable database query, validation results, the quantitative metrics, the qualitative metrics, and reasoning information generated during an entity identification, the intent identification, the table determination, at least one candidate executable database query generation, the validation of at least one candidate executable database query, and the confidence score computation;
determining, by the processor, a user expertise level and a role associated with the at least one user based on a user profile and the received request;
applying, by the processor, the data results, the confidence score, the intermediate artifacts, the reasoning information and features corresponding to the determined user expertise level and the role to the GenAI model;
generating, by the processor, a natural-language explanation as an output of the GenAI model, wherein the natural-language explanation comprises a description of reasoning performed at each step of the entity identification, the intent identification, the table selection, the candidate query generation, the validation, and an interpretation of the confidence score, a summary in a non-technical language, and a detailed step-by-step technical explanation;
generating, by the processor, at least one visual representation corresponding to the natural-language explanation using the GenAI model;
generating, by the processor, a set of contextually relevant dynamic filter dimensions and hierarchy levels for performing one of a drill-down action and a drill-through action on the at least one visual representation; and
generating, by the processor, the response comprising the at least one visual representation, the generated output data, the confidence score, the generated natural-language explanation, and the relevant dynamic filter dimensions.

19. The method of claim 11, wherein validating the generated at least one candidate executable database query using a syntactic analysis model, and iteratively refine the at least one candidate executable database query to generate a validated executable database query comprises:
generating, by processor, an abstract syntax tree representation by parsing the at least one candidate executable database query and validating the abstract syntax tree representation for at least one of syntactic completeness level, a join completeness level, a filter applicability, and compliance with database-engine constraints;
performing, by the processor, a semantic validation on the at least one candidate executable database query by comparing referenced tables, the fields, the metrics, and the dimensions with the identified plurality of entities and a subgraph of the knowledge-graph referred during entity identification;
validating, by the processor, the at least one candidate executable database query by comparing the at least one candidate executable database query with pre-determined syntactic conditions and semantic conditions;
generating, by the processor, validation-error information corresponding to the at least one candidate executable database query based on results of validation; and
iteratively re-generating, by the processor, at least one executable database query using the GenAI model until at least one candidate executable database query meets the determined syntactic conditions and the semantic conditions.

20. A non-transitory computer readable medium comprising a processor-executable instructions that cause a processor to:
receive a request for generating a response corresponding to a domain from at least one user, wherein the request comprises a natural language query;
identify a plurality of entities and an intent of the received request by parsing the natural language query using a hybrid vector and graph model;
determine at least one of candidate tables, fields, metrics, and dimensions relevant to the natural language query by querying a knowledge graph based on the identified plurality of entities and the intent, wherein the knowledge graph comprises at least one of table metadata nodes, field nodes, dimension nodes, organization term nodes, organization metric nodes, synonym nodes, acronym nodes, user-query nodes, tip nodes, table-behavior nodes, and weighted relationships between each type of node;
generate at least one candidate executable database query based on the determined candidate tables, the fields, the metrics, and the dimensions relevant to the natural language query using at least one Generative Artificial Intelligence (GenAI) model;
validate the generated at least one candidate executable database query using a syntactic analysis model, and iteratively refine the at least one candidate executable database query to generate a validated executable database query;
generate output data corresponding to the natural language query by executing the validated executable database query on at least one structured data source;
compute a confidence score for the validated executable database query based on at least one of quantitative metrics and qualitative metrics using a classifier model;
generate a response to the natural language query based on the computed confidence score and the generated output data, wherein the response comprises the computed confidence score, and an explanation of reasoning performed in generating and validating the executable database query; and
output the response on a user interface of a user device.
